(19) United States
(12) Patent Application Publication
(10) Pub. No.: US 2025/0142521 A1
(43) Pub. Date: May 1, 2025

(54) BASE STATION AND COMMUNICATION METHOD

(71) Applicant: NTT DOCOMO, INC., Tokyo (JP)

(72) Inventors: Shohei Yoshioka, Chiyoda-ku, Tokyo (JP); Satoshi Nagata, Chiyoda-ku, Tokyo (JP); Luhua You, Haidian District, Beijing (CN); Weiqi Sun, Haidian District, Beijing (CN); Jing Wang, Haidian District, Beijing (CN); Lan Chen, Haidian District, Beijing (CN); Jinming Zhao, Haidian District, Beijing (CN); Yong Li, Haidian District, Beijing (CN)

(73) Assignee: NTT DOCOMO, INC., Tokyo (JP)

(21) Appl. No.: 18/837,801

(22) PCT Filed: Feb. 21, 2022
(86) PCT No.: PCT/JP2022/007054

§ 371 Date: Aug. 12, 2024

(51) Int. Cl. H04W 64/00; H04L 5/00; H04W 56/00; H04W 84/06

(52) U.S. Cl. CPC H04W 64/00; H04L 5/0053; H04W 56/005; H04W 84/06

(57) ABSTRACT

A base station in a network system includes: a transmission unit configured to transmit a first reference signal to a terminal via a first non-terrestrial communication device; and a reception unit configured to receive information related to a reception timing at the terminal from the terminal. The transmission unit transmits information related to a propagation delay of the first reference signal and information related to the reception timing to LMF (Location Management Function), and the information related to the reception timing is a time difference between a reception timing of the first reference signal and a reception timing of a second reference signal that is transmitted from the base station or from a second base station that is different from the base station via a second non-terrestrial communication device.

### FIELD OF THE INVENTION

The present invention relates to a base station and a communication method in a wireless communication system.

### BACKGROUND OF THE INVENTION

Regarding NR (New Radio) (also referred to as “5G”), or a successor system to LTE (Long Term Evolution), technologies have been discussed which satisfy the following requirements: a high capacity system, high data transmission rate, low delay, simultaneous connection of multiple terminals, low cost, power saving, etc. (for example, Non-Patent Document 1).

Currently, NTN (Non-Terrestrial Network) is also discussed. The NTN provides services to an area that cannot be covered by a terrestrial 5G network mainly due to the cost aspect, by using a non-terrestrial network such as a satellite (Non-Patent Document 2 and Non-Patent Document 3).

### CITATION LIST

### Non-Patent Document

Non-Patent Document 1: 3GPP TS 38.300 V16.8.0 (2021-12)
Non-Patent Document 2: 3GPP TR 38.821 V16.0.0 (2019-12)
Non-Patent Document 3: Konishi, et al., “A Study of Downlink Spectrum Sharing in HAPS Mobile Communication Systems”, The Institute of Electronics, Information and Communication Engineers (IEICE) General Conference, B-17-1, 2020
Non-Patent Document 4: 3GPP TS 38.305 V16.7.0 (2021-12)
Non-Patent Document 5: 3GPP TS 38.455 V16.6.0 (2021-12)
Non-Patent Document 6: 3GPP TS 37.355 V16.7.0 (2021-12)
Non-Patent Document 7: 3GPP TS 23.032 V16.1.0 (2021-12)
Non-Patent Document 8: 3GPP TS 38.215 V16.4.0 (2020-12)

### SUMMARY OF THE INVENTION

### Technical Problem

For example, in order to be adapted to the regulatory requirements of each country related to the lawful interception, emergency call, PWS (Public Warning System), or the like, the location information of a terminal is required to be verified by the network. Here, in the next-generation system (for example, NTN (Non-Terrestrial Network)), the distance between the base station in the air and the terminal is very large and the communication path includes the feeder link and the service link, and thus, the network cannot sufficiently verify the location information of the terminal by using the conventional method.

The present invention has been made in view of the above points, and it is an object of the present invention to perform positioning of the terminal in the network system.

### Solution to Problem

According to the disclosed technology, a base station in a network system is provided. The base station includes: a transmission unit configured to transmit a first reference signal to a terminal via a first non-terrestrial communication device; and a reception unit configured to receive information related to a reception timing at the terminal from the terminal. The transmission unit transmits information related to a propagation delay of the first reference signal and information related to the reception timing to LMF (Location Management Function), and the information related to the reception timing is a time difference between a reception timing of the first reference signal and a reception timing of a second reference signal that is transmitted from the base station or from a second base station that is different from the base station via a second non-terrestrial communication device.

### Advantageous Effects of Invention

According to the disclosed technique, positioning of the terminal can be performed in the network system.

### BRIEF DESCRIPTION OF THE DRAWINGS

FIG. 1 is a drawing illustrating an example (1) of an NTN.

FIG. 2 is a drawing illustrating an example (2) of an NTN.

FIG. 3 is a drawing illustrating an example (3) of an NTN.

FIG. 4 is a drawing illustrating an example (4) of an NTN.

FIG. 5 is a drawing illustrating an example (5) of an NTN.

FIG. 6 is a drawing illustrating an example (1) of positioning.

FIG. 7 is a drawing illustrating an example of measuring DL-RSTD.

FIG. 8 is a drawing illustrating an example of measuring UL-RTOA.

FIG. 9 is a drawing illustrating an example (2) of positioning.

FIG. 10 is a drawing illustrating an example of measuring RTT.

FIG. 11 is a drawing illustrating an example of NTN in an embodiment of the present invention.

FIG. 12 is a drawing illustrating an example of the SFN initialization time in an embodiment of the present invention.

FIG. 13 is a drawing illustrating an example of the DL reception time difference in an embodiment of the present invention.

FIG. 14 is a drawing illustrating an example of delay between the TRP and the satellite in an embodiment of the present invention.

FIG. 15 is a drawing illustrating an example of delay between the TRP and the RP in an embodiment of the present invention.

FIG. 16 is a drawing illustrating the delay between the RP and the satellite in an embodiment of the present invention.

FIG. 17 is a drawing illustrating an example of the UL reception time difference in an embodiment of the present invention.

FIG. 18 is a drawing illustrating an example of RTT in an embodiment of the present invention.

FIG. 19 is a drawing illustrating an example of a functional configuration of a base station 10 in an embodiment of the present invention.

FIG. 20 is a drawing illustrating an example of a functional configuration of a terminal 20 in an embodiment of the present invention.

FIG. 21 is a drawing illustrating an example of a hardware structure of the base station 10 or the terminal 20 in an embodiment of the present invention.

FIG. 22 is a drawing illustrating an example of a structure of a vehicle 2001 in an embodiment of the present invention.

### DETAILED DESCRIPTION OF THE PREFERRED EMBODIMENTS

In the following, referring to the drawings, one or more embodiments of the present invention will be described. It should be noted that the embodiments described below are examples. Embodiments of the present invention are not limited to the following embodiments.

In operations of a wireless communication system according to an embodiment of the present invention, a conventional technique will be used when it is appropriate. With respect to the above, for example, the conventional techniques are related to, but not limited to, the existing LTE. Further, it is assumed that the term “LTE” used in the present specification has, unless otherwise specifically mentioned, a broad meaning including a scheme of LTE-Advanced and a scheme after LTE-Advanced (e.g., NR).

Furthermore, in one or more embodiments described below, terms that are used in the existing LTE are used, such as SS (Synchronization signal), PSS (Primary SS), SSS (Secondary SS), PBCH (Physical broadcast channel), PRACH (Physical random access channel), PDCCH (Physical Downlink Control Channel), PDSCH (Physical Downlink Shared Channel), PUCCH (Physical Uplink Control Channel), PUSCH (Physical Uplink Shared Channel), etc. The above-described terms are used for the sake of description convenience. Signals, functions, etc., which are similar to the above-described terms, may be referred to as different names. Further, the above terms in NR correspond to NR-SS, NR-PSS, NR-SSS, NR-PBCH, NR-PRACH, NR-PDCCH, NR-PDSCH, NR-PUCCH, NR-PUSCH, and the like. However, even when a signal is used for NR, there may be a case in which the signal is not referred to as “NR-”.

In addition, in an embodiment of the present invention, the duplex method may be a TDD (Time Division Duplex) method, an FDD (Frequency Division Duplex) method, or any other method (e.g., Flexible Duplex, or the like).

Further, in an embodiment of the present invention, the expression, radio (wireless) parameters are “configured (set)” may mean that a predetermined value is pre-configured, or may mean that a radio parameter indicated by a base station 10 or a terminal 20 is configured.

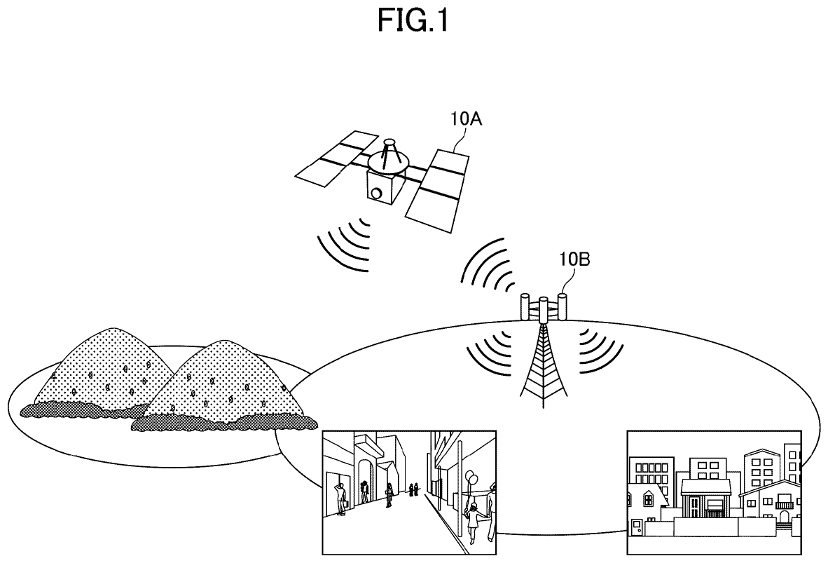

FIG. 1 is a drawing illustrating an example (1) of NTN. The NTN provides services to an area that cannot be covered by a terrestrial 5G network mainly due to the cost aspect, by using a non-terrestrial device such as a satellite. Further, services with higher reliability may be provided by NTN. For example, NTN may be assumed to be applied to IoT (Inter of things), ships, buses, trains, and critical communications. Further, NTN has scalability according to efficient multi-cast or broadcast.

As an example of NTN, as illustrated in FIG. 1, a satellite 10A can provide services to an area such as a mountainous area in which a terrestrial base station is not arranged, by performing retransmission of a signal transmitted by a terrestrial base station 10B.

Note that the terrestrial 5G network may have a structure as described below. The terrestrial 5G network may include one or more base stations 10 and terminals 20. The base station 10 is a communication device that provides one or more cells and performs wireless communication with the terminal 20. Physical resources of the radio signal may be defined in the time domain and the frequency domain, the time domain may be defined by the number of OFDM symbols, and the frequency domain may be defined by the number of sub-carriers or resource blocks. The base station 10 transmits a synchronization signal and system information to the terminal 20. The synchronization signal is, for example, an NR-PSS and an NR-SSS. The system information is transmitted via, for example, a NR-PBCH, and may be referred to as broadcast information.

The base station 10 transmits a control signal or data in DL (Downlink) to the terminal 20 and receives a control signal or data in UL (Uplink) from the terminal 20. The base station 10 and terminal 20 are capable of transmitting and receiving a signal by performing the beamforming. Further, the base station 10 and the terminal 20 can both apply MIMO (Multiple Input Multiple Output) communication to DL or UL. Further, both the base station 10 and terminal 20 may perform communications via an SCell (Secondary Cell) and a PCell (Primary Cell) using CA (Carrier Aggregation).

The terminal 20 may be a communication apparatus that includes a wireless communication function such as a smartphone, a mobile phone, a tablet, a wearable terminal, a communication module for M2M (Machine-to-Machine), or the like. The terminal 20 uses various communication services provided by a wireless communication system, by receiving a control signal or data in DL from the base station 10 and transmitting a control signal or data in UL to the base station 10.

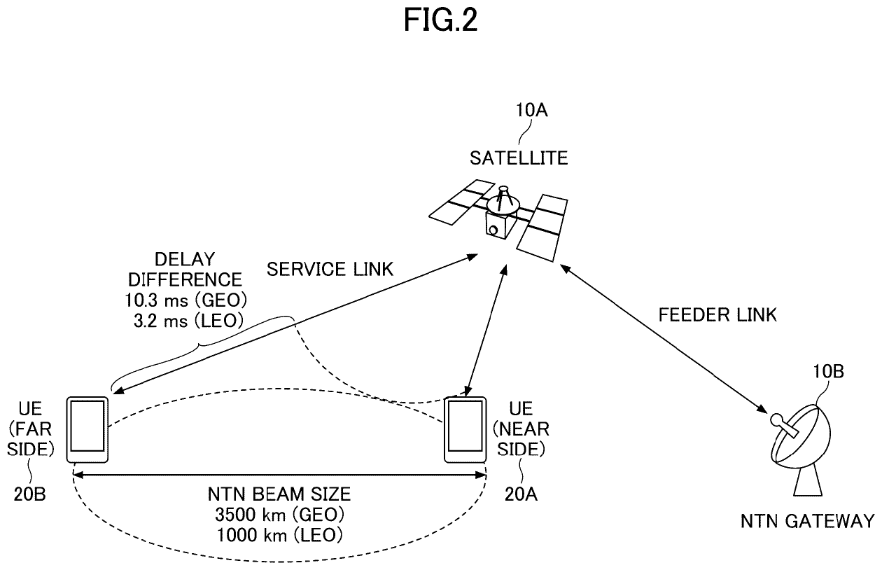

FIG. 2 is a drawing illustrating an example (2) of NTN. In NTN, a cell or an area for each beam is very large when compared with a terrestrial network, TN. FIG. 2 illustrates an example of NTN including retransmissions by a satellite. The connection between a satellite 10A and an NTN gateway 10B is referred to as a feeder link, and the connection between the satellite 10A and a UE 20 is referred to as a service link.

As illustrated in FIG. 2, the delay difference between the near side UE 20A and the far side UE 20B is, for example, 10.3 ms in a case of GEO (Geosynchronous orbit), and 3.2 ms in a case of LEO (Low Earth orbit). Further, the beam size in NTN is, for example, 3,500 km in a case of GEO, and 1,000 km in a case of LEO.

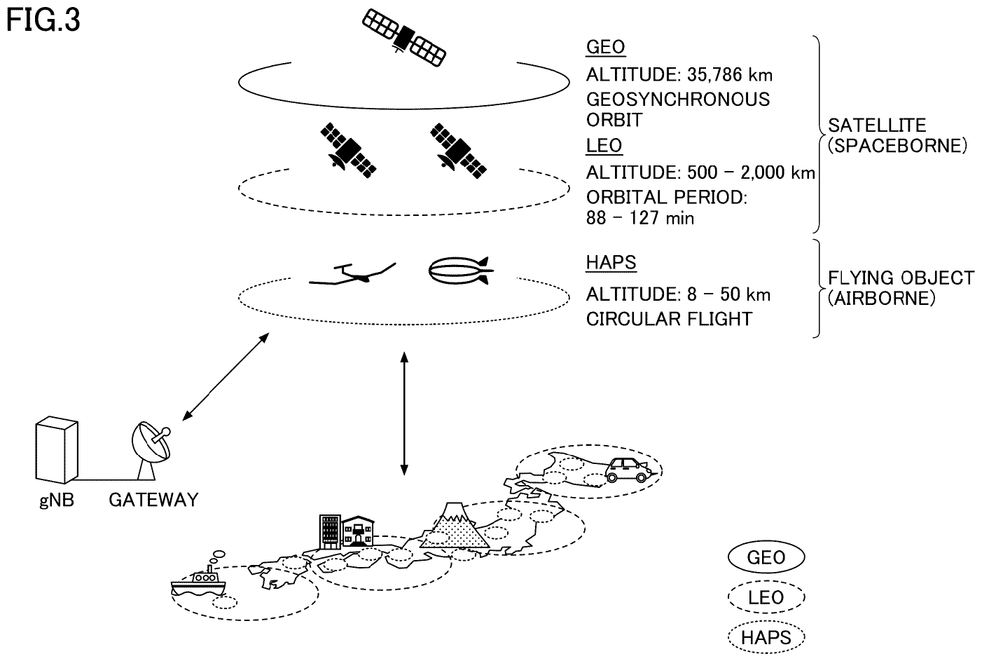

FIG. 3 is a drawing illustrating an example (3) of NTN. As illustrated in FIG. 3, NTN is implemented by a satellite in space or a flying object in the air. For example, the GEO satellite may be a satellite located at an altitude 35,786 km, in a geosynchronous orbit. For example, the LEO satellite may be a satellite located at an altitude 500 to 2,000 km, with an orbital period of 88 to 127 minutes. For example, HAPS (High Altitude Platform Station) may be a flying object located at an altitude of 8 to 50 km that flies on a circular flight path.

As illustrated in FIG. 3, the GEO satellite, the LEO satellite and the HAPS flying object may be connected to a terrestrial station gNB via a gateway. In addition, the service area increases in the order of HAPS, LEO, and GEO.

For example, the coverage of the 5G network can be enhanced by NTN, with respect to the area with no service and the area with services. In addition, for example, the continuity, availability, and reliability of services in the ship, bus, train or other important communications can be improved by NTN. Note that NTN may be indicated by transmitting a dedicated parameter to the terminal 20, and the dedicated parameter may be, for example, a parameter related to TA (Timing Advance) determination based on the information related to the satellite or the flying object.

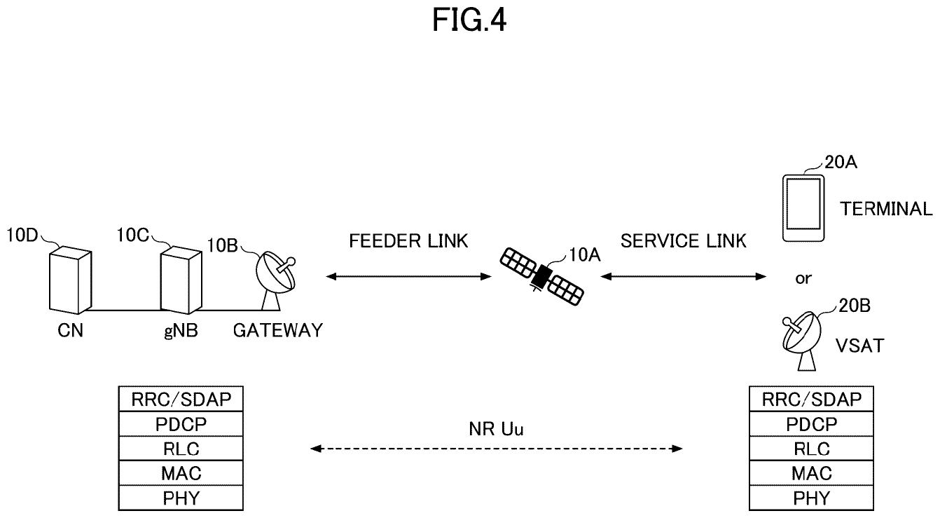

FIG. 4 is a drawing illustrating an example (4) of NTN. FIG. 4 illustrates an example of an NTN network architecture that is assumed in a case of transparent payload. As illustrated in FIG. 4, a CN (Core Network) 10D, a gNB 10C and a gateway 10B are connected. The gateway 10B is connected to a satellite 10A via a feeder link. The satellite 10A is connected to a terminal 20A or a VSAT (Very small aperture terminal) 20B via a service link. NR Uu is established between the gNB 10C and the terminal 20A or VSAT 20B.

In addition, as an assumption of the NTN network architecture, FDD may be adopted, or TDD may be available. In addition, the terrestrial cell may be fixed or movable. In addition, the terminal 20 may have GNSS (Global Navigation Satellite System) capability. For example, in FR1, a hand-held device with power class 3 may be assumed. In addition, a VSAT device may be assumed to be at least in FR2.

In addition, a regenerative payload may be assumed in the NTN network architecture. For example, a gNB function may be installed in the satellite or the flying object. In addition, a gNB-DU may be installed in the satellite or the flying object, and a gNB-CU may be arranged as a terrestrial station.

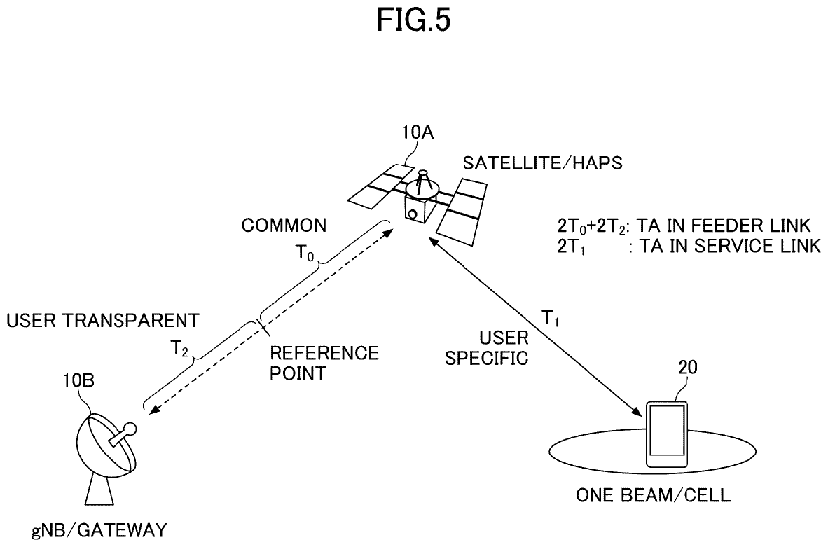

FIG. 5 is a drawing for describing an example of a timing advance in an NTN. As illustrated in FIG. 5, the TA in the NTN is a sum of the TA of the feeder link and the TA of the service link. The TA of the feeder link is RTD (Round trip delay)=2 (T₀+T₂). The T₂ is compensated for by the network, corresponds to TA between the reference point and the gNB/gateway, and is a user-transparent value. The T₀ is a TA common to all users. It is to be noted that the reference point can be configured in the service link, and, in this case, the T₀ will be a negative value.

The TA of the service link is RTD=2T₁. The T₁ is a user-specific TA, and varies depending on the location of the UE 20.

The TA in the NTN may be calculated according to, for example, TA=(N_{TA}+N_{TA,UE-specific}+N_{TA,common}+N_{TA,offset})*Tc. The N_{TA,common} is a TA common to all users. Hereinafter, the N_{TA,common} is also referred to as a common TA. The N_{TA,UE-specific} is a UE-specific TA. The N_{TA} is indicated by a TA command. The N_{TA,offset} is a fixed value defined in the technical specifications. It is to be noted that N_{TA,UE-specific}+N_{TA,common} is not required to be multiplied by T_{C}.

For example, in order to be adapted to the regulatory requirements of each country related to the lawful interception, emergency call, PWS (Public Warning System), or the like, the location information of the terminal 20 is required to be verified by the network. In other words, the network is required to have a capability of verifying the location information reported by the terminal 20. For example, the network is required to be capable of estimating the location information of the terminal 20.

In order to verify the validity of the location information reported by the terminal 20, the network is required to have a capability of deriving the location of the terminal 20. Hereinafter, how the network, for example, LMF (Location Management Function) calculates the location of the terminal 20 will be discussed.

The positioning in the conventional TN (Terrestrial Network) is performed by using methods of 1) to 3) described below (refer to non-patent document 4, non-patent document 5, and non-patent document 6).
1) Method based on DL-TDOA (Time Difference of Arrival)
2) Method based on UL-TDOA
3) Method based on multi-RTT (Round Trip Time).

With respect to the positioning in the NTN in an embodiment of the present invention, the positioning in the above-described TN may be reused. For example, the TRP (Transmission Reception Point) may be a terrestrial transmission point that is connected to a satellite. It is to be noted that the TRP may be a set of antennas that are located at the same geographical location and support functions of TP (Transmission Point) and/or RP (Reception Point). Alternatively, a satellite may be defined as a TRP.

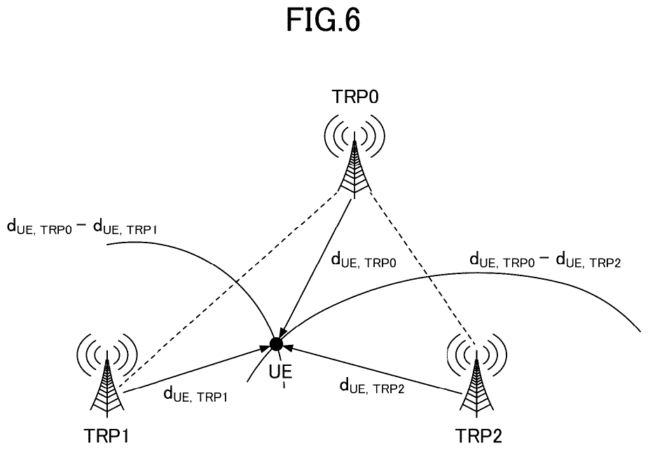

FIG. 6 is a drawing illustrating an example (1) of positioning. As illustrated in FIG. 6, the location information of the UE may be calculated based on DL-TDOA in the TN. The location of the UE may be estimated based on DL-RSTD (Received Signal Time Difference) in which the UE measures DL wireless signals transmitted from a plurality of NR TRPs. The geographical locations of the TRPs and the DL transmission timings at the TRPs may be used in the estimation. Furthermore, the location of the UE may be estimated based on RSRP (Reference Signal Received Power) of DL-PRS (Positioning Reference Signal) in addition to DL-RSTD.

For example, as illustrated in FIG. 6, the location of the UE may be calculated based on the geographical location and the DL transmission timing of each of the TRPs by measuring the delay between the UE and the TRP0, the delay between the UE and the TRP1, and the delay between the UE and the TRP2.

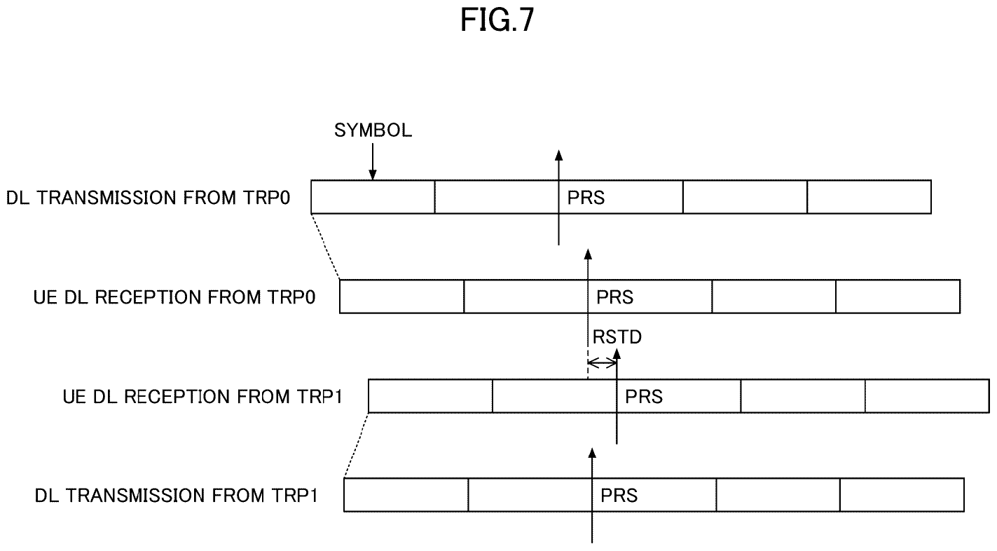

FIG. 7 is a drawing illustrating an example of measuring DL-RSTD. The UE may report the DL-RSTD as a measurement result to the GW and/or gNB and/or LMF by using the LPP (LTE Positioning Protocol). Hereinafter, “and/or” will be also described as “/”. As illustrated in FIG. 7, the DL-RSTD may refer to the time difference, measured by the UE, between the time point of the start of reception of a DL subframe from a reference TRP (TRP0 in FIG. 7) and the time point of the start of reception of a DL subframe from another TRP. The start of a subframe may be determined by detecting the DL-PRS.

The transmission timing of each of the TRPs is not required to be the same, and the gNB may report the timing information related to the TRP to the LMF by using the NRPPa (NR Positioning Protocol A). The LMF may calculate the location of the UE based on the above-described information reported by the UE and the gNB.

Regarding the calculation of the location of the UE according to DL-TDOA, information described in 1) to 5) below may be reported from the UE to the GW/gNB/LMF.
1) PCI (Physical Cell ID), GCI (Global Cell ID), and TRP-ID in each measurement
2) DL-RSTD measurement result
3) DL-PRS-RSRP measurement result
4) Measurement time (time stamp)
5) Quality of each measurement

Regarding the calculation of the location of the UE according to DL-TDOA, information described in 1) to 6) below may be reported from the gNB to the LMF.
1) PCI, GCI, and TRP-ID of TRPs controlled by the gNB
2) Timing information of TRPs controlled by the gNB
3) DL-PRS configuration of TRPs controlled by the gNB
4) SSB-related information, such as SSB time and frequency resources, of TRPs controlled by the gNB
5) Spatial direction information of the DL-PRS of TRPs controlled by the gNB
6) Geographical coordinates information of TRPs controlled by the gNB

DL-RSTD may be defined as the time difference, measured by the UE, between the time point of the start of reception of a DL subframe from a reference TRP and the time point of the start of reception of a DL subframe from another TRP. A plurality of DL-PRS resources may be used for determining the time point of the start of reception of a subframe.

The SFN initialization time of the TRPs may be reported as a report of the timing information related to the TRPs controlled by the gNB. The SFN initialization time is the beginning time of SFN0.

The ellipsoid point with altitude and the ellipsoid with uncertainty range may be reported as a report of the geographical coordinates information of TRPs controlled by the gNB (refer to non-patent document 7). For example, the latitude, longitude, altitude, direction of altitude, uncertainty range of altitude, or the like, may be reported.

As illustrated in FIG. 6, the location information of the UE may be calculated based on UL-TDOA in the TN. The location of the UE may be estimated based on the UL-RTOA (Relative Time of Arrival) in which the UL wireless signal transmitted from the UE is measured by a plurality of NR TRPs. Other configuration information items may be used for the estimation. Furthermore, the location of the UE may be estimated based on RSRP of UL-SRS (Sounding Reference Signal) in addition to the UL-RTOA.

For example, as illustrated in FIG. 6, the location of the UE may be calculated based on the geographical location and the UL transmission timing of each of the TRPs by measuring the RTOA from the UE to the TRP0, the RTOA from the UE to the TRP1, and the RTOA from the UE to the TRP2.

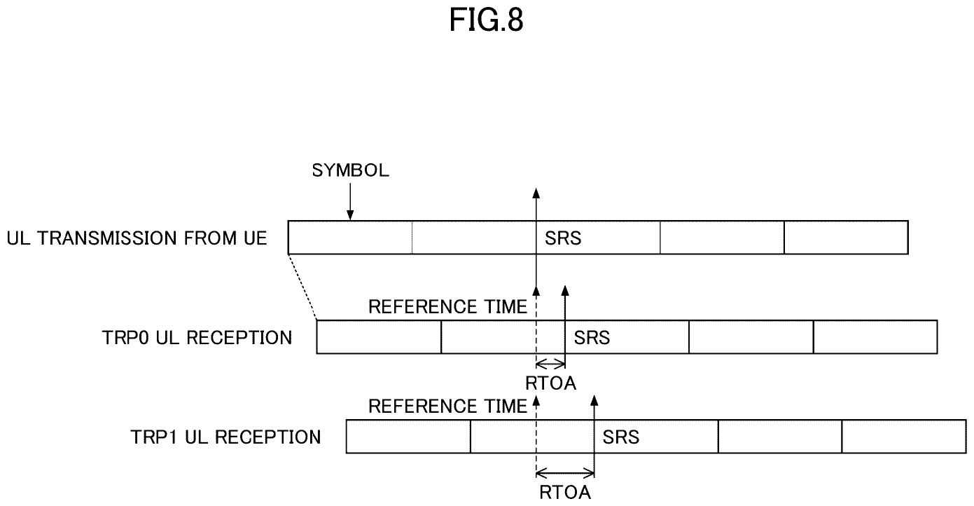

FIG. 8 is a drawing illustrating an example of measuring UL-RTOA. The gNB may report the UL-RTOA as a measurement result to the LMF by using NRPPa. As illustrated in FIG. 8, the UL-RTOA may refer to the time difference between the time point of the start of reception of a UL subframe including SRS at the TRP and the RTOA reference time at which the UL is transmitted. The gNB may report the geographical coordinates of the TRP to the LMF by using NRPPa. The LMF may calculate the location of the UE based on the above-described information reported by the gNB.

Regarding the calculation of the location of the UE according to UL-TDOA, information described in 1) to 9) below may be reported from the gNB to the LMF.
1) PCI, GCI, and TRP-ID of TRPs controlled by the gNB
2) SSB-related information, such as SSB time and frequency resources, of TRPs controlled by the gNB
3) Geographical coordinates information of TRPs controlled by the gNB
4) NCGI (NR Cell Global Identifier) and TRP-ID of the measurement
5) UL-RTOA
6) RSRP of UL-SRS
7) Time of the measurement
8) Quality of each measurement
9) Beam information of each measurement

The UL-RTOA may be defined as the time difference between the time point of the start of reception of a UL subframe including SRS at the TRP and the RTOA reference time at which the UL is transmitted. The gNB may report the geographical coordinates of the TRP to the LMF by using NRPPa.

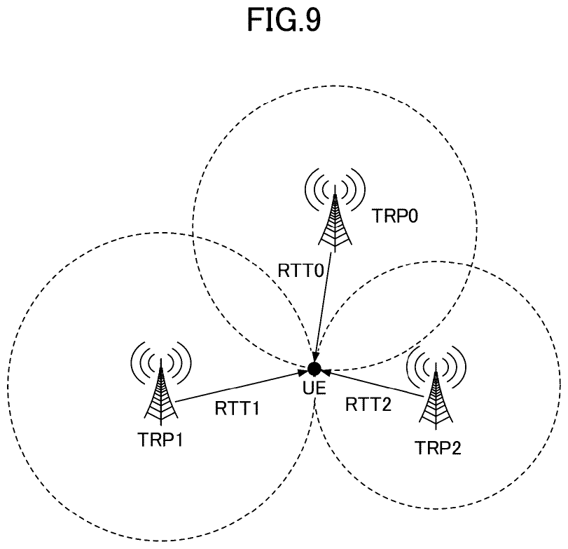

FIG. 9 is a drawing illustrating an example (2) of positioning. As illustrated in FIG. 9, the location information of the UE may be calculated based on a plurality of RTTs in the TN. The location of the UE may be estimated based on the UE/gNB reception-transmission time difference measurement using DL-PRS and UL-SRS. DL-PRS-RSRP and UL-SRS-RSRP may be used for the estimation. The LMF may determine the RTT by using the UE/gNB reception-transmission time difference measurement.

For example, as illustrated in FIG. 9, the location of the UE may be calculated based on the geographical location of each of the TRPs by measuring the RTT between the UE and the TRP0, the RTT between the UE and the TRP1, and the RTT between the UE and the TRP2.

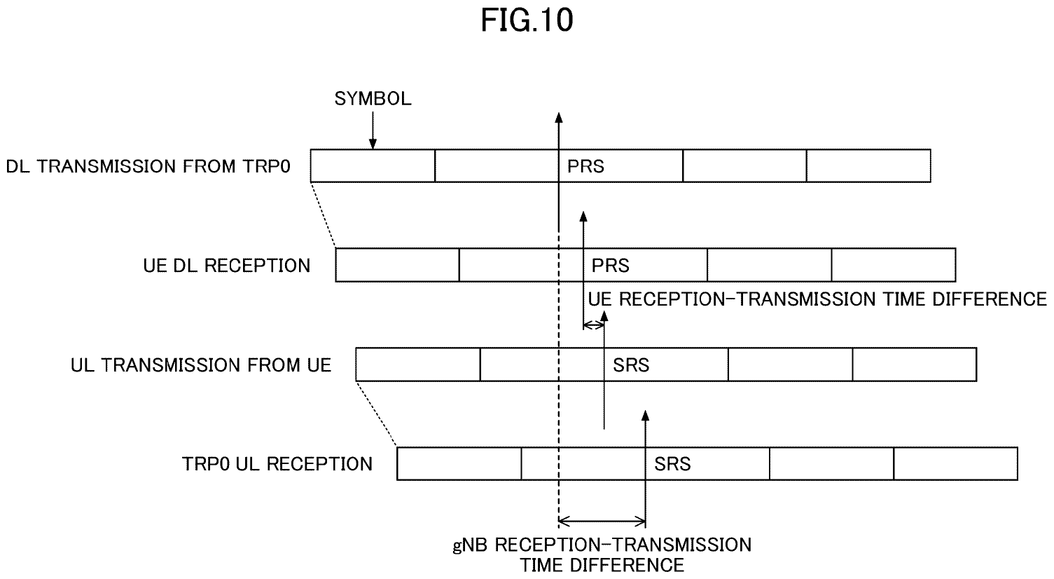

FIG. 10 is a drawing illustrating an example of measuring RTT. As illustrated in FIG. 10, the UE may report, as the UE reception transmission time difference, the time difference between the timing of receiving a DL subframe from the TRP and the timing of transmitting a UL subframe. In addition, as illustrated in FIG. 10, the gNB may report, as the gNB reception-transmission time difference, the time difference between the timing of receiving a UL subframe by the TRP and the timing of transmitting a DL subframe by the TRP. The LMF may calculate the location of the UE based on the above-described information reported by the UE and the gNB.

Regarding the calculation of the location of the UE according to a plurality of RTTs, information described in 1) to 5) below may be reported from the UE to the GW/gNB/LMF.
1) PCI, GCI, and TRP-ID in each measurement
2) DL-PRS-RSRP measurement result
3) UE reception-transmission time difference measurement result
4) Time of the measurement
5) Quality of each measurement

Regarding the calculation of the location of the UE according to RTTs, information described in 1) to 9) below may be reported from the gNB to the LMF.
1) PCI, GCI, and TRP-ID of TRPs controlled by the gNB
2) Timing information of TRPs controlled by the gNB
3) DL-PRS configuration of TRPs controlled by the gNB
4) SSB-related information, such as SSB time and frequency resources, of TRPs controlled by the gNB
5) Spatial direction information of the DL-PRS of TRPs controlled by the gNB
6) Geographical coordinates information of TRPs controlled by the gNB
7) NCGI and TRP-ID of the measurement
8) gNB reception-transmission time difference
9) RSRP of UL-SRS
10) UL-AoA (Angle of Arrival), for example, azimuth and elevation
11) Time of the measurement
12) Quality of the measurement
13) Beam information of the measurement

It is to be noted that the definitions of the UE reception-transmission time difference and the gNB reception-transmission time difference may be referred to in non-patent document 8. The geographical coordinates of the TRP may be reported in the same way as the DL-RSTD.

As described above, in the TN scenario, the positioning methods according to the DL-TDOA, the UL-TDOA, and the multi-RTT that respectively use the RSTD, the RTOA, and the reception-transmission time difference, which indicate the propagation delay between the UE and the TRP, are applied. On the other hand, in the NTN scenario, the location of the UE is derived from the information related to the propagation delay between the satellite and the UE.

Here, in the three time-based positioning methods in the NTN, what type of information is to be transmitted from the UE to the GW/gNB/LMF is required to be determined. In addition, what type of information is to be transmitted from the gNB to the LMF is required to be determined.

It is to be noted that the movement of the satellite is required to be taken into account as a characteristic of the NTN. With respect to the above point, for example, the existing assistance information including the orbital information of the satellite and the common TA parameter may be reused.

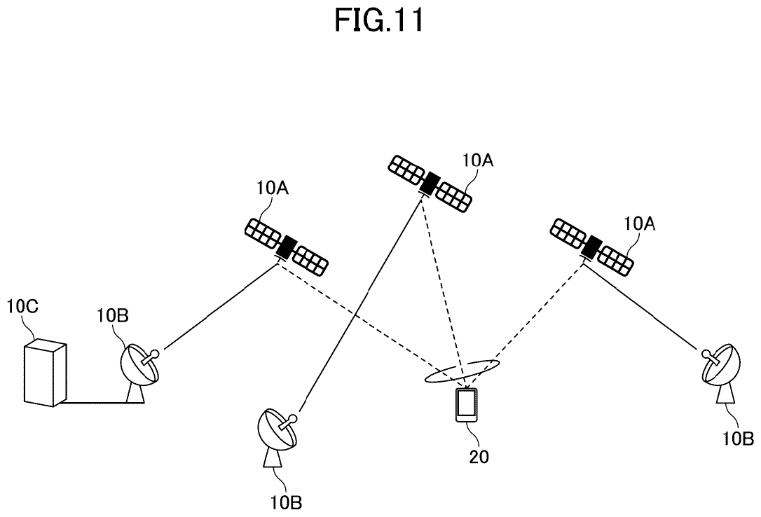

FIG. 11 is a drawing illustrating an example of NTN in an embodiment of the present invention. In the positioning according to the DL-TDOA, the RSTD refers to the reception time difference of the reference signal between the different TRPs and the UE. In the positioning according to the DL-TDOA in the NTN, as illustrated in the dashed line in FIG. 11, the RSTD refers to the reception time difference of the reference signal between the different satellites and the UE. Here, how to accurately obtain RSTD from different satellites to the UE is not clarified for the LMF. In addition, in the positioning according to the DL-TDOA in the NTN, the LMF is required to obtain the geographical location of each of the satellites. However, how to report the locations of the satellites to the LMF is not clarified.

In addition, in the positioning according to the UL-TDOA, the RTOA refers to the SRS reception time at the TRP relative to the RTOA reference time. In the positioning according to the UL-TDOA in the NTN, with respect to the RTOA, unlike the TN, the feeder link and the service link are required to be taken into account. In other words, the reception time at the satellite is required. Here, how to accurately obtain RTOA from different satellites is not clarified for the LMF. In addition, in the positioning according to the UL-TDOA in the NTN, the LMF is required to obtain the geographical location of each of the satellites. However, how to report the locations of the satellites to the LMF is not clarified.

In addition, in the positioning according to a plurality of RTTS, with respect to the UE/gNB reception-transmission time difference, the reception-transmission time difference from different TRPs to the UE is referred to by the UE/gNB. In the positioning according to a plurality of RTTs in the NTN, with respect to the reception-transmission time difference, the reception-transmission time difference from the satellites to the UE is required to be taken into account. Here, how to accurately obtain RTTs for the different satellites and the UE is not clarified for the LMF. In addition, in the positioning according to a plurality of RTTs in the NTN, the LMF is required to obtain the geographical location of each of the satellites. However, how to report the locations of the satellites to the LMF is not clarified.

Accordingly, the following proposals from a proposal 1) to a proposal 4) described below may be performed.
Proposal 1) Report of DL-RSTD by the UE and the report of the timing information by the gNB
Proposal 2) Report of the satellite location by the gNB
Proposal 3) Report of UL-RTOA by the gNB
Proposal 4) Report of the reception-transmission time difference by the UE and the reception-transmission time difference by the gNB
Proposal 1) The UE may support the reporting of DL reception time difference to the GW/gNB/LMF by using LPP. It is to be noted that, hereinafter, the TRP may be a satellite.

The UE may report the measured DL reception time difference from two TRPs. The two TRPs may be two TRPs controlled by the same gNB, and may be connected to two satellites. The two satellites may be connected to the same GW or different GWs. Alternatively, the two TRPs may be two TRPs controlled by the corresponding gNBs, and may be connected to two satellites. The two satellites may be connected to the same GW or different GWs. It is to be noted that the information reported by the UE may be transferred to the LMF via the TRP/gNB/GW.

In addition, the gNB may report the timing information of information 1) to information 4) described below to the LMF by using NRPPa.
Information 1) SFN initialization time, measured by the gNB, at the TRP controlled by the gNB or GW. Hereinafter, the SFN initialization time at the TRPx will be referred to as T_x.
Information 2) Propagation delay, calculated by the gNB, between the TRP controlled by the gNB or GW and the satellite. Furthermore, the gNB may report, as information 2a, the assistance information for the LMF to calculate the propagation delay to the LMF.
Information 3) Propagation delay, calculated by the gNB, between the TRP controlled by the gNB or GW and the reference point. Hereinafter, the propagation delay at the TRPx will be referred to as Ta_x. Furthermore, the gNB may report, as information 3a, the assistance information for the LMF to calculate the propagation delay to the LMF. The reference point may be a reference point that is defined for the NTN in the 3GPP release 17. In other words, the reference point is a reference with respect to the DL timing and the UL timing. Alternatively, the reference point may be newly defined.
Information 4) Propagation delay, calculated by the gNB, between the reference point and the satellite. Hereinafter, the propagation delay related to the TRPx will be referred to as Tb_x. Furthermore, the gNB may report, as information 4a, the assistance information for the LMF to calculate the propagation delay to the LMF. The reference point may be a reference point that is defined for the NTN in the 3GPP release 17. In other words, the reference point is a reference with respect to the DL timing and the UL timing. Alternatively, the reference point may be newly defined.

Regarding the report of the above-described information 1) to the above-described information 4), the following options from an option 1) to an option 9) may be applied. It is to be noted that the options from an option 5) to an option 9) are options for a case in which two TRPs are connected to the same gNB.
Option 1) The information 1 and the information 2 (or information 2a) may reported separately for each TRP/each TRP pair.
Option 2) The information 1, the information 3 (or information 3a), and the information 4 (or information 4a) may reported separately for each TRP/each TRP pair.
Option 3) The gNB may calculate the information 1 and the information 2 as a single value for each TRP/each TRP pair and report the value to the LMF. For example, the SFN initialization time at the satellite that is obtained by adding the propagation delay from the TRP/GW/gNB to the satellite to the SFN initialization time at the TRP/GW/gNB may be defined as the single value.
Option 4) The gNB may calculate the information 1 and the information 3 as a single value for each TRP/each TRP pair and report the value to the LMF. For example, the SFN initialization time at the reference point that is obtained by adding the propagation delay from the TRP/GW/gNB to the reference point to the SFN initialization time at the TRP/GW/gNB may be defined as the single value. Furthermore, the gNB may additionally or separately report the information 4 to the LMF.
Option 5) The gNB may calculate the time difference between the TRPx and the TRPy and report the time difference to the LMF in a case where the two TRPs are connected to the same gNB or connected to different gNBs. For example, three values of T_x−T_y, Ta_x−Ta_y, and Tb_x−Tb_y may be reported.
Option 6) The gNB may calculate time differences of the information 1 and the information 3 between the TRPx and the TRPy and report the time differences as a single value to the LMF in a case where the two TRPs are connected to the same gNB or connected to different gNBs. For example, (T_x−T_y)+ (Ta_x−Ta_y) may be reported. Furthermore, the gNB may additionally or separately report the time difference of the information 4 between the TRPx and the TRPy to the LMF. For example, Tb_x−Tb_y may be reported.
Option 7) The gNB may calculate time differences of the information 3 and the information 4 between the TRPx and the TRPy and report the time differences as a single value to the LMF in a case where the two TRPs are connected to the same gNB or connected to different gNBs. For example, (Ta_x−Ta_y)+ (Tb_x−Tb_y) may be reported. Furthermore, the gNB may additionally or separately report the time difference of the information 1 between the TRPx and the TRPy to the LMF. For example, T_x−T_y may be reported.
Option 8) The gNB may calculate time differences of the information 1 and the information 2 between the TRPx and the TRPy and report the time differences as a single value to the LMF in a case where the two TRPs are connected to the same gNB or connected to different gNBs. The single value may correspond to the time difference of the propagation delay from the TRP/GW/gNB to the satellite, and (T_x−T_y)+ (Ta_x−Ta_y)+ (Tb_x−Tb_y) may be reported, for example.
Option 9) In a case where the two TRPs are connected to the same gNB or connected to different gNBs, the gNB may obtain the time difference of the propagation delay from the satellite to the UE between the TRPx and the TRPy by calculating the difference between the TRPx and the TRPy in the same way as the RSTD reported by the UE, and the time difference may be reported to the LMF or the time difference may be directly applied to the LMF.

It is to be noted that, in the above-described option 5) to option 8), (T_x−T_y)=0 at the TRP/GW/gNB in a case where the transmission times of the two TRPs are completely the same. In addition, (T_x−T_y)+ (Ta_x−Ta_y)=0 at the reference point. In addition, (T_x−T_y)+ (Ta_x−Ta_y)+ (Tb_x−Tb_y)=0 at the satellite.

According to the operation described above, the positioning according to DL-TDOA in the TN can be enhanced for the NTN scenario. In addition, necessary information can be reported from the UE and the gNB to the LMF. In addition, the signaling overhead can be reduced in a case where a single value corresponding to a plurality of information items at a TRP (for example, information items from information 1 to information 4) is reported, or in a case where a single value corresponding to a plurality of information items related to two TRPs whose difference is to be reported is reported. In addition, calculation resources required to the gNB can be reduced and information items of different parts will be clarified in a case where a plurality of information items corresponding to a TRP are reported by using a plurality of values, for example, each of information items is separately reported, or in a case where a plurality of information items related to two TRPs are reported by using a plurality of values, for example, information items are reported for each TRP.

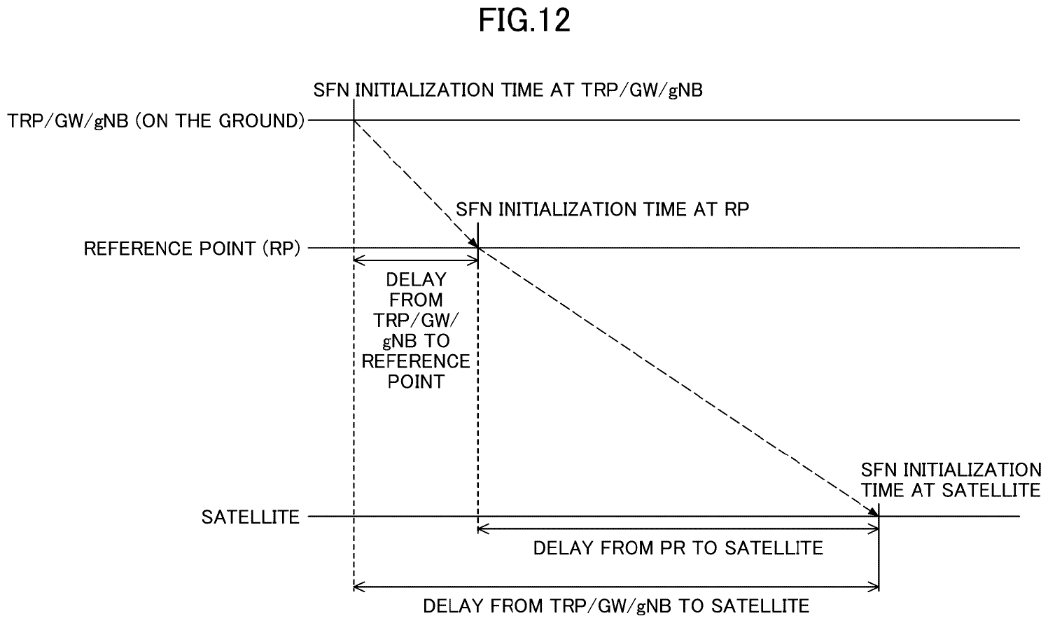

FIG. 12 is a drawing illustrating an example of the SFN initialization time in an embodiment of the present invention. As illustrated in FIG. 12, the SFN initialization time at the reference point is obtained by adding the delay from the TRP/GW/gNB to the reference point to the initialization time at the TRP/GW/gNB. In addition, the SFN initialization time at the satellite is the time obtained by adding the delay from the reference point to the satellite to the initialization time at the reference point. In addition, the SFN initialization time at the satellite is the time obtained by adding the delay from the TRP/GW/gNB to the satellite to the initialization time at the TRP/GW/gNB.

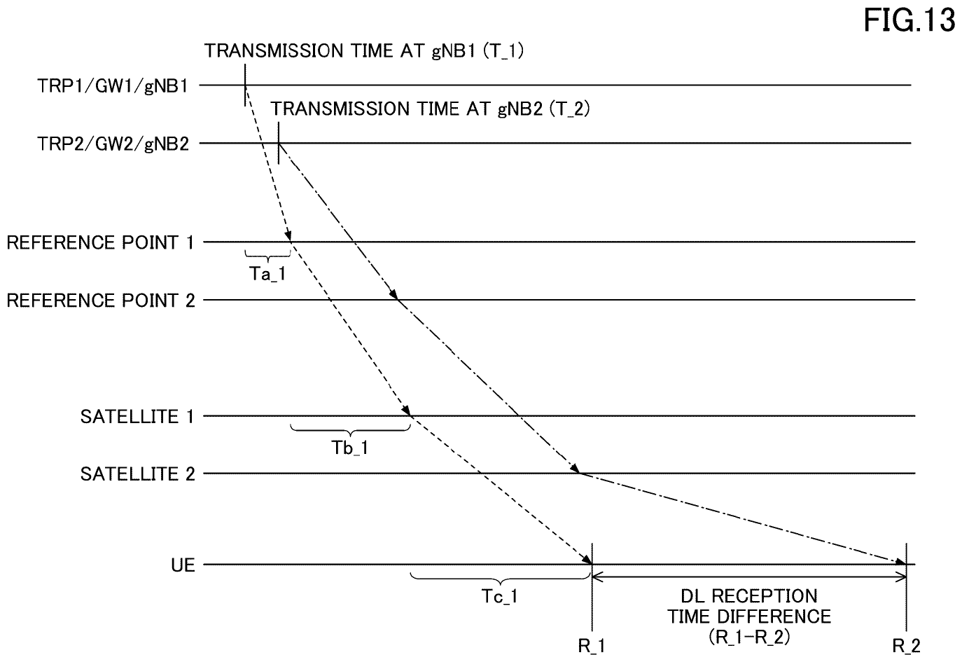

FIG. 13 is a drawing illustrating an example of the DL reception time difference in an embodiment of the present invention. As illustrated in FIG. 13, hereinafter, with respect to the TRPx, the propagation delay between the satellite and the UE will be referred to as Tc_x, and, with respect to the TRPx and the TRPy, the DL reception time difference at the UE will be referred to as R_x−R_y. The TRP1 and the TRP2 are illustrated in FIG. 13. Here, R_x−R_y=(T_x−T_y)+ (Ta_x−Ta_y)+ (Tb_x−Tb_y)+ (Tc_x−Tc_y). The LMF needs a value related to Tc_x in order to calculate the location of the UE, for example, (Tc_x−Tc_y). The values that are reported to the LMF in the above-described option 1) to the above-described option 9) will be described below by referring to FIG. 13. It is to be noted that the report by the UE may be reported to the LMF via the gNB.
Option 1) The UE reports R_x−R_y for each TRP pair and the gNB reports two values, T_x and Ta_x+Tb_x, for each TRP.
Option 2) The UE reports R_x−R_y for each TRP pair and the gNB reports three values, T_x, Ta_x, and Tb_x, for each TRP.
Option 3) The UE reports R_x−R_y for each TRP pair and the gNB reports one value, T_x+Ta_x+Tb_x, for each TRP.
Option 4) The UE reports R_x−R_y for each TRP pair and the gNB reports two values, T_x+Ta_x and Tb_x, for each TRP.
Option 5) In a case where two TRPs are connected to the same gNB, or connected to different gNBs, the UE reports R_x−R_y and the gNB reports three valued, T_x−T_y, Ta_x−Ta_y, and Tb_x−Tb_y.
Option 6) In a case where two TRPs are connected to the same gNB, or connected to different gNBs, the UE reports R_x−R_y, and the gNB reports two values, (T_x−T_y)+ (Ta_x−Ta_y) and Tb_x−Tb_y.
Option 7) In a case where two TRPs are connected to the same gNB, or connected to different gNBs, the UE reports R_x−R_y, and the gNB reports two values, T_x−T_y and (Ta_x−Ta_y)+ (Tb_x−Tb_y).
Option 8) In a case where two TRPs are connected to the same gNB, or connected to different gNBs, the UE reports R_x−R_y and the gNB reports one value, (T_x−T_y)+ (Ta_x−Ta_y)+ (Tb_x−Tb_y).
Option 9) In a case where two TRPs are connected to the same gNB, or connected to different gNBs, the UE reports R_x−R_y, and the gNB reports one value, (R_x−R_y)−(T_x−T_y)−(Ta_x−Ta_y)−(Tb_x−Tb_y). The above-described value corresponds to Tc_x−Tc_y.

It is to be noted that the TRP/GW/gNB, the reference point and the satellite can be a single point (that is, the same geographical point) in the NTN. In a case of a single point, Ta_x+Tb_x=0 and the TRP/GW/gNB is assumed to be mounted on the satellite. In addition, in a case of Ta_x=0, the TRP/GW/gNB and the reference point are assumed to be a single point, and, in a case of Tb_x=0, the reference point and the satellite are assumed to be a single point.

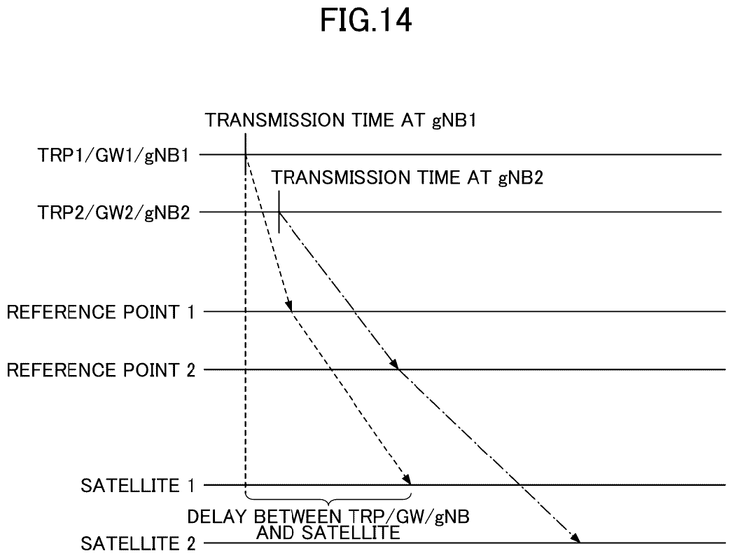

FIG. 14 is a drawing illustrating an example of delay between the TRP and the satellite in an embodiment of the present invention. As illustrated in FIG. 14, the gNB may report the information related to the delay between the TRP controlled by the gNB or GW and the satellite to the LMF.

For example, the gNB may directly report the delay value between the TRP controlled by the gNB or GW and the satellite. In the same way as the report of the information related to the feeder link delay of the 3GPP release 17, for example, in the same way as the report of the one way propagation delay or the distance by using the NRPPa messages reporting the delay between the TRP/GW/gNB and the satellite, a sum of K_mac and the common TA may be used. K_mac may be a parameter that is received via MAC-CE and is related to the determination of the configuration application timing. In addition, a new IE (Information Element) may be introduced, or new information may be introduced to the existing IE.

In addition, for example, the gNB may report the location of the TRP controlled by the gNB or GW to the LMF. The LMF may calculate the delay between the TRP controlled by the gNB or GW and the satellite, based on the location. The conventional geographical coordinate report of the TRP may be used for the report related to the location of the TRP controlled by the gNB or GW. The report related to the location of the satellite will be described below.

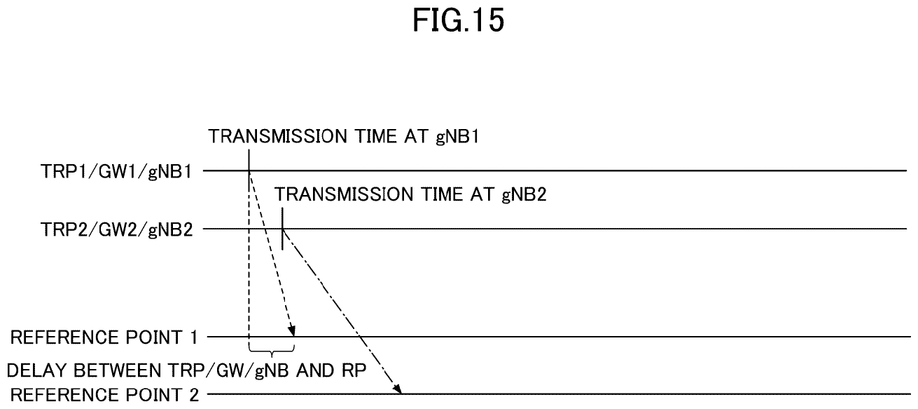

FIG. 15 is a drawing illustrating an example of delay between the TRP and the RP in an embodiment of the present invention. As illustrated in FIG. 15, the gNB may report the information related to the delay between the TRP controlled by the gNB or GW and the reference point to the LMF.

For example, the gNB may directly report the value of the delay between the TRP controlled by the gNB or GW and the reference point. In the same way as the report of the one way propagation delay or the distance by using the NRPPa messages reporting the delay between the TRP/GW/gNB and the reference point in the 3GPP release 17, K_mac may be reused. In addition, a new IE may be introduced, or new information may be introduced to the existing IE.

In addition, for example, the gNB may report the location of the TRP controlled by the gNB or GW and the location of the reference point to the LMF. The LMF may calculate the delay between the TRP controlled by the gNB or GW and the reference point, based on the locations. The conventional geographical coordinate report of the TRP may be used for the report related to the location of the TRP controlled by the gNB or GW. The location information of the reference point in the 3GPP release 17 may be applied for the report related to the location of the reference point in a case where the same definition as the reference point in the 3GPP release 17 is applied, that is, in a case of the DL/UL timing synchronization point. Alternatively, the conventional report of the geographical coordinates may be reused.

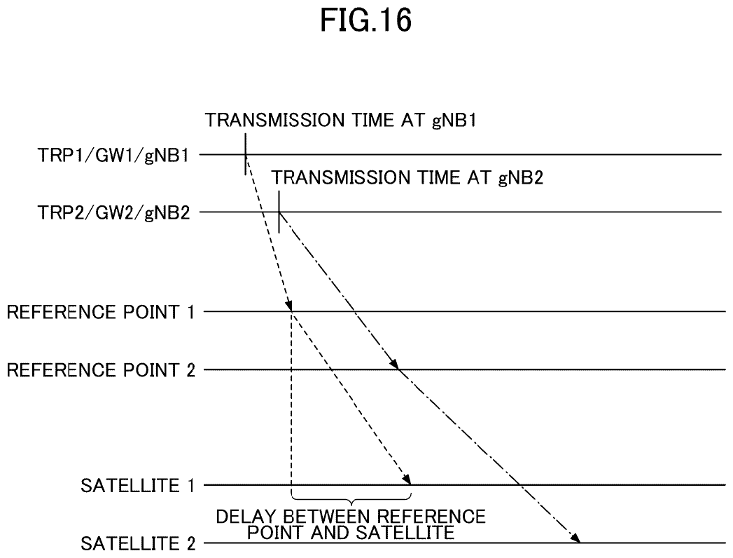

FIG. 16 is a drawing illustrating the delay between the RP and the satellite in an embodiment of the present invention. As illustrated in FIG. 16, the gNB may report the information related to the delay between the reference point and the satellite to the LMF.

For example, the gNB may directly report the value of the delay between the reference point and the satellite. The one way propagation delay/distance report/common TA by using the NRPPa messages in the 3GPP release 17 may be reused for the report of the delay between the TRP/GW/gNB and the reference point, for example. In addition, a new IE may be introduced, or new information may be introduced to the existing IE.

In addition, for example, the gNB may report the location of the reference point and the location of the satellite to the LMF. The LMF may calculate the delay between the reference point and the satellite, based on the locations. The NRPPa messages may be reused for the location report of the reference point that is configured to the network. A new IE may be introduced, or new information may be introduced to the existing IE. For example, a new NRPPa message may be defined for the location report of the reference point, or, a new field of the IE indicating the geographical coordinates of the NTN reference point may be added to the existing NRPPa messages.

Proposal 2) The gNB may report the information related to the location of the satellite to the LMF. For example, the gNB may report the geographical coordinates of the satellite by using the NRPPa messages. The report of the geographical coordinates of the TRP in the 3GPP release 17 may be reused for the report of the geographical coordinates of the satellite. A new IE may be introduced, or new information may be introduced to the existing IE. For example, a new NRPPa message may be defined for the location report of the satellite, or, a new field of the IE indicating the geographical coordinates of the satellite may be added to the existing NRPPa messages.

In addition, for example, the gNB may report the location of the satellite, {X, Y, Z} [m] in the ECEF coordinate system (Earth-centered, Earth-fixed coordinate system) and the velocity, {VX, VY, VZ} [m/s] to the LMF.

In addition, for example, the gNB may report the orbital information of the satellite to the LMF. For example, the semi-major axis a [m], the eccentricity e, the argument of periapsis @ [rad], the longitude of ascending node 2 [rad], the inclination i [rad], the mean anomaly M [rad] at epoch time to may be reported. Proposal 3) The gNB may support the reporting of UL reception time to the LMF by using NRPPa. For example, the gNB may report the UL-SRS reception time, measured by the gNB, relative to the RTOA reference time at the TRP controlled by the gNB or GW to the LMF. It is to be noted that the TRP may be a satellite.

In addition, the gNB may report the timing information of information 1) to information 3) described below to the LMF by using NRPPa.

Information 1) Propagation delay, calculated by the gNB, between the TRP controlled by the gNB (or, gNB and GW) and the satellite. Furthermore, the gNB may report, as information 1a, the assistance information for the LMF to calculate the propagation delay to the LMF.

Information 2) Propagation delay, calculated by the gNB, between the TRP controlled by the gNB (or, gNB and GW) and the reference point. Hereinafter, the propagation delay at the TRPx will be referred to as Ta_x. Furthermore, the gNB may report, as information 2a, the assistance information for the LMF to calculate the propagation delay to the LMF. The reference point may be a reference point that is defined in the 3GPP release 17. In other words, the reference point is a reference with respect to the DL timing and the UL timing. Alternatively, the reference point may be newly defined.

Information 3) Propagation delay, calculated by the gNB, between the reference point and the satellite. Hereinafter, the propagation delay related to the TRPx will be referred to as Tb_x. Furthermore, the gNB may report, as information 3a, the assistance information for the LMF to calculate the propagation delay to the LMF. The reference point may be a reference point that is defined in the 3GPP release 17. In other words, the reference point is a reference with respect to the DL timing and the UL timing. Alternatively, the reference point may be newly defined.

Regarding the report of the above-described information 1) to the above-described information 3), the following options from an option 1) to an option 8) may be applied. It is to be noted that the options from an option 5) to an option 8) are options for a case in which two TRPs are connected to the same gNB. It is to be noted that the UL-RTOA received at the TRPx will be referred to as RTOA_x.
Option 1) The UL-RTOA and the information 1 (or information 1a) may reported separately for each TRP.
Option 2) The UL-RTOA, the information 2 (or information 2a), and the information 3 (or information 3a) may reported separately for each TRP.
Option 3) The gNB may calculate the UL-RTOA and the information 1 as a single value for each TRP and report the value to the LMF. For example, with respect to the RTOA at the satellite, the time obtained by subtracting the propagation delay from the TRP/GW/gNB to the satellite from the UL-SRS reception time at the TRP/GW/gNB may be defined as the single value.
Option 4) The gNB may calculate the UL-RTOA and the information 2 as a single value for each TRP and report the value to the LMF. For example, with respect to the RTOA at the reference point, the time obtained by subtracting the propagation delay from the TRP/GW/gNB to the reference point from the UL-SRS reception time at the TRP/GW/gNB may be defined as the single value. Furthermore, the gNB may additionally or separately report the information 3 to the LMF.
Option 5) The gNB may calculate the time difference of the information 1 between the TRPx and the TRPy and the time difference of the UL-RTOA between the TRPx and the TRPy, and report the time differences to the LMF in a case where the two TRPs are connected to the same gNB or connected to different gNBs. For example, two values of Ta_x−Ta_y and Tb_x−Tb_y may be reported as the time difference of the information 1.
Option 6) The gNB may calculate time difference of the UL-RTOA and the time difference of the information 2 between the TRPx and the TRPy and report the time differences as a single value to the LMF in a case where the two TRPs are connected to the same gNB or connected to different gNBs. For example, (RTOA_x−RTOA_y)−(Ta_x−Ta_y) may be reported. Furthermore, the gNB may additionally or separately report the time difference of the information 3 between the TRPx and the TRPy to the LMF. For example, Tb_x−Tb_y may be reported.
Option 7) The gNB may calculate and report the UL-RTOA between the TRPx and the TRPy, and calculate the time differences of the information 2 and the information 3 as a single value and report the value to the LMF in a case where the two TRPs are connected to the same gNB or connected to different gNBs. For example, (Ta_x−Ta_y)+ (Tb_x−Tb_y) may be reported as the time differences of the information 2 and the information 3.
Option 8) The gNB may calculate time differences of the information 2 and the information 3 between the TRPx and the TRPy and report the time differences as a single value to the LMF in a case where the two TRPs are connected to the same gNB or connected to different gNBs. The single value may correspond to the time difference of the propagation delay from the TRP/GW/gNB to the satellite, and (RTOA_x−RTOA_y)−(Ta_x−Ta_y)−(Tb_x−Tb_y) may be reported, for example.

It is to be noted that, in the above-described option 5) to option 8), (T_x−T_y)=0 at the TRP/GW/gNB in a case where the transmission times of the two TRPs are completely the same. In addition, (T_x−T_y)+ (Ta_x−Ta_y)=0 at the reference point. In addition, (T_x−T_y)+ (Ta_x−Ta_y)+ (Tb_x−Tb_y)=0 at the satellite.

According to the operation described above, the positioning according to UL-TDOA in the TN can be enhanced for the NTN scenario. In addition, necessary information can be reported from the UE and the gNB to the LMF. In addition, the signaling overhead can be reduced in a case where a single value corresponding to a plurality of information items at a TRP (for example, information items from information 1 to information 3) is reported, or in a case where a single value corresponding to a plurality of information items related to two TRPs whose difference is to be reported is reported. In addition, calculation resources required by the gNB can be reduced and information items of different parts will be clarified in a case where a plurality of information items corresponding to a TRP are reported by using a plurality of values, for example, each of information items is separately reported, or in a case where a plurality of information items related to two TRPs are reported by using a plurality of values, for example, information items are reported for each TRP.

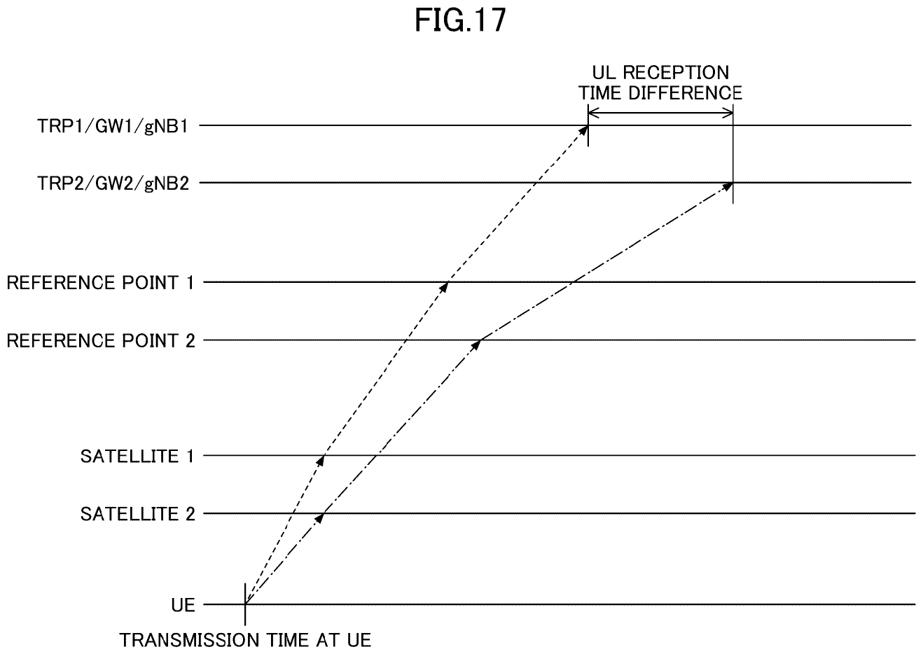

FIG. 17 is a drawing illustrating an example of the UL reception time difference in an embodiment of the present invention. As illustrated in FIG. 17, hereinafter, with respect to the TRPx, the propagation delay between the satellite and the UE will be referred to as Tc_x. Here, with respect to the TRPx and the TRPy, RTOA_x−RTOA_y=(Ta_x−Ta_y)+ (Tb_x−Tb_y)+ (Tc_x−Tc_y). The TRP1 and the TRP2 are illustrated in FIG. 17. The LMF needs a value related to Tc_x, for example, (Tc_x−Tc_y), in order to calculate the location of the UE. The values that are reported to the LMF in the above-described option 1) to the above-described option 8) will be described below by referring to FIG. 17.
Option 1) The gNB reports two values, RTOA_x and Ta_x+Tb_x, for each TRP.
Option 2) The gNB reports three values, RTOA_x, Ta_x, and Tb_x, for each TRP.
Option 3) The gNB reports a single value, RTOA_x−Ta_x−Tb_x, for each TRP. The single value is Tc_x.
Option 4) The gNB reports two values, RTOA_x−Ta_x and Tb_x, for each TRP.
Option 5) In a case where two TRPs are connected to the same gNB, or connected to different gNBs, the gNB reports three values, RTOA_x−RTOA_y, Ta_x−Ta_y, and Tb_x−Tb_y.
Option 6) In a case where two TRPs are connected to the same gNB, or connected to different gNBs, the gNB reports two values, (RTOA_x−RTOA_y)−(Ta_x−Ta_y) and Tb_x−Tb_y.
Option 7) In a case where two TRPs are connected to the same gNB, or connected to different gNBs, the gNB reports two valued, RTOA_x−RTOA_y and (Ta_x−Ta_y)+ (Tb_x−Tb_y).
Option 8) In a case where two TRPs are connected to the same gNB, or connected to different gNBs, the gNB reports a single value, (RTOA_x−RTOA_y)−(Ta_x−Ta_y)−(Tb_x−Tb_y). The single value is Tc_x−Tc_y.

It is to be noted that the TRP/GW/gNB, the reference point and the satellite can be a single point (that is, the same geographical point) in the NTN. In a case of a single point, Ta_x+Tb_x=0 and the TRP/GW/gNB is assumed to be mounted on the satellite. In addition, in a case of Ta_x=0, the TRP/GW/gNB and the reference point are assumed to be a single point, and, in a case of Tb_x=0, the reference point and the satellite are assumed to be a single point.
Proposal 4) The UE may support the reporting of reception-transmission time difference to the GW/gNB/LMF by using LPP. It is to be noted that, hereinafter, the TRP may be a satellite.

The UE may report the measured reception-transmission time difference related to the TRP. It is to be noted that the information that is reported to the TRP/gNB/GW from the UE may be forwarded to the LMF via the TRP/gNB/GW.

In addition, the gNB may report the timing information of information 1) to information 4) described below to the LMF by using NRPPa.
Information 1) The reception-transmission time difference, measured by the gNB, at the TRP controlled by the gNB or GW.
Information 2) RTT, calculated by the gNB, between the TRP controlled by the gNB or GW and the satellite. Furthermore, the gNB may report, as information 2a, the assistance information for the LMF to calculate the propagation delay between the TRP controlled by the gNB or GW and the satellite to the LMF.
Information 3) RTT, calculated by the gNB, between the TRP controlled by the gNB or GW and the reference point. Furthermore, the gNB may report, as information 3a, the assistance information for the LMF to calculate the propagation delay between the TRP controlled by the gNB or GW and the reference point to the LMF. The reference point may be a reference point that is defined in the 3GPP release 17. In other words, the reference point is a reference with respect to the DL timing and the UL timing. Alternatively, the reference point may be newly defined.
Information 4) RTT, calculated by the gNB, between the reference point and the satellite. Furthermore, the gNB may report, as information 4a, the assistance information for the LMF to calculate the propagation delay between the reference point and the satellite to the LMF. The reference point may be a reference point that is defined in the 3GPP release 17. In other words, the reference point is a reference with respect to the DL timing and the UL timing. Alternatively, the reference point may be newly defined.

Regarding the report of the above-described information 1) to the above-described information 4), the following options from an option 1) to an option 4) may be applied.
Option 1) The gNB reception-transmission time difference and the information 2 (or the information 2a) may reported individually.
Option 2) The gNB reception-transmission time difference, the information 3 (or information 3a), and the information 4 (or information 4a) may be reported individually.
Option 3) The gNB may calculate the gNB reception-transmission time difference and the information 1 as a single value and report the value to the LMF. For example, the reception transmission time difference at the satellite may be reported by referring to a value obtained by subtracting the propagation delay between the TRP/GW/gNB and the satellite from the DL-PRS and UL-SRS reception time at the TRP/GW/gNB.
Option 4) The gNB may calculate the gNB reception-transmission time difference and the information 3 as a single value and report the value to the LMF. For example, the reception-transmission time difference at the reference point may be reported by referring to a value obtained by subtracting the propagation delay between the TRP/GW/gNB and the reference point from the DL-PRS and UL-SRS reception time at the TRP/GW/gNB. Furthermore, the gNB may additionally or separately report the information 4 to the LMF.

According to the operation described above, the positioning according to a plurality of RTTs in the TN can be enhanced for the NTN scenario. In addition, necessary information can be reported from the UE and the gNB to the LMF. In addition, the signaling overhead can be reduced in a case where a single value corresponding to a plurality of information items at a TRP (for example, information items from information 1 to information 4) is reported, or in a case where a single value corresponding to a plurality of information items related to two TRPs whose difference is to be reported is reported. In addition, calculation resources required by the gNB can be reduced and information items of different parts will be clarified in a case where a plurality of information items corresponding to a TRP are reported by using a plurality of values, for example, each of information items is separately reported, or in a case where a plurality of information items related to two TRPs are reported by using a plurality of values, for example, information items are reported for each TRP.

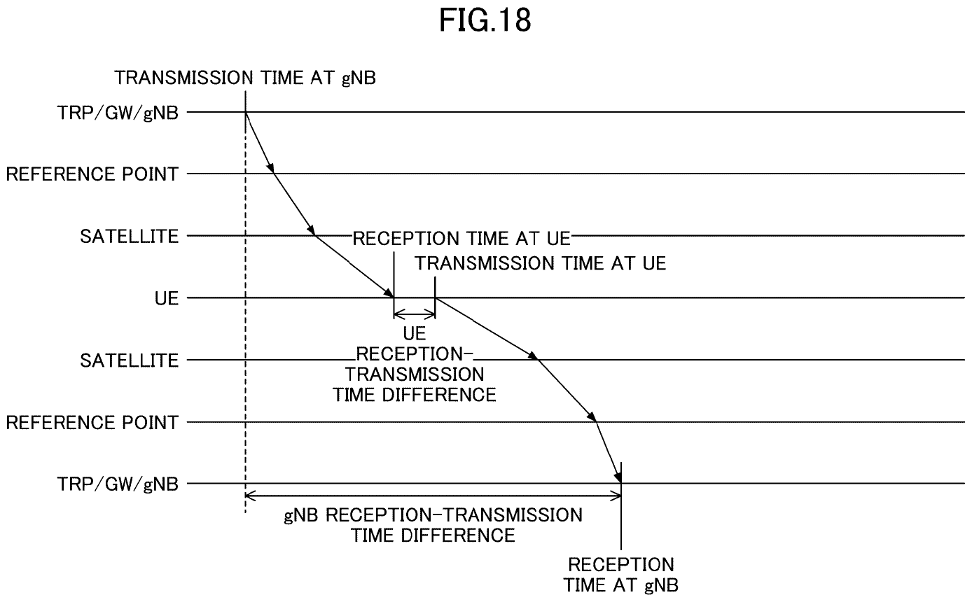

FIG. 18 is a drawing illustrating an example of RTT in an embodiment of the present invention. In the RTT illustrated in FIG. 18, the information described in the following (a) to (f) can be defined.
(a) UE reception-transmission time difference
(b) TRP/GW/gNB reception-transmission time difference
(c) RTT between the TRP/GW/gNB and the satellite
(d) RTT between the TRP/GW/gNB and the reference point
(e) RTT between the reference point and the satellite
(f) RTT between the satellite and the UE

It is to be noted that (f) is necessary for the LMF to perform positioning of the UE.

The information to be measured by the UE among the above-described information items is (a). The information to be reported by the UE among the above-described information items is (a). The information to be measured by the gNB among the above-described information items is (b), and the gNB may measure the DL-PRS and UL-PRS reception time at the TRP/GW/gNB. The information to be calculated by the gNB among the above-described information items is (c), (d), (e), and (c)+ (d).

The information to be reported from the gNB to the LMF among the above-described information items is (b) and (c) for the above-described option 1, (b), (d), and (e) for the above-described option 2, (b)-(c) for the above-described option 3, and (b)-(d) and (e) for the above-described option 4.

In the above-described embodiment, the satellite may be replaced with a non-terrestrial communication device including a satellite, HAPS, and the like.

According to the above-described embodiment, in the NTN environment, the gNB and the UE can report the information necessary for positioning of the UE to the LMF, and the LMF can perform positioning of the UE based on the information.

In other words, positioning of the terminal can be performed in the network system.

### (Device Configuration)

Next, a functional configuration example of the base station 10 and the terminal 20 for performing the processes and operations described above will be described. The base station 10 and the terminal 20 include functions for implementing the embodiments described above. It should be noted, however, that each of the base stations 10 and the terminal 20 may include only some of the functions in an embodiment.

### <Base Station 10>

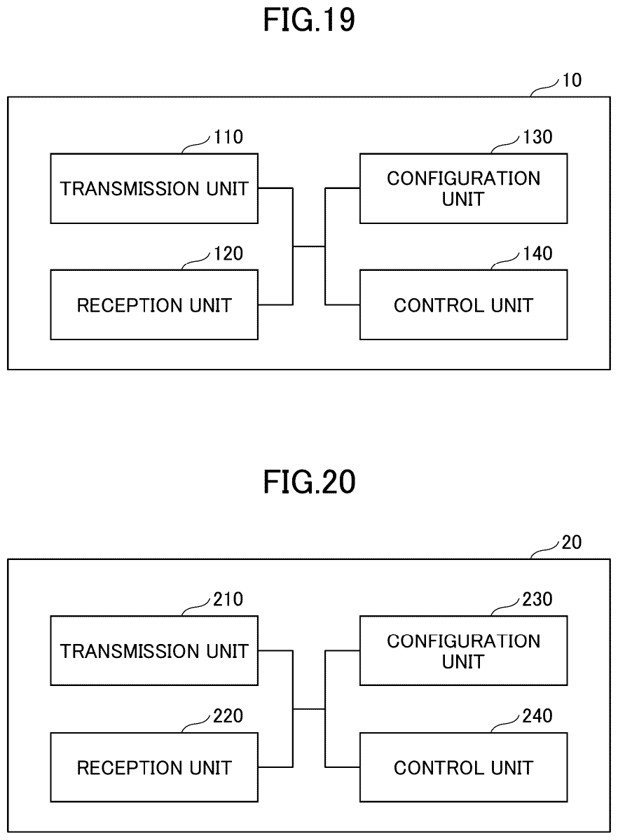

FIG. 19 is a drawing illustrating an example of a functional configuration of a base station 10 according to an embodiment of the present invention. As shown in FIG. 19, the base station 10 includes a transmission unit 110, a reception unit 120, a configuration unit 130, and a control unit 140. The functional configuration illustrated in FIG. 19 is merely an example. Functional divisions and names of functional units may be anything as long as operations according to an embodiment of the present invention can be performed. In addition, the network node such as the LMF may have a similar configuration as the base station 10.

The transmission unit 110 includes a function for generating a signal to be transmitted to the terminal 20 side and transmitting the signal wirelessly. Further, the transmission unit 110 transmits an inter-network-node message to another network node. The reception unit 120 includes a function for receiving various signals transmitted from the terminal 20 and acquiring, for example, information of a higher layer from the received signals. Further, the transmission unit 110 has a function to transmit NR-PSS, NR-SSS, NR-PBCH, DL/UL control signals, and the like to the terminal 20. Further, the reception unit 120 receives an inter-network-node message from another network node.

The configuration unit 130 stores preset information and various configuration information items to be transmitted to the terminal 20. Contents of the configuration information are, for example, information related to communications in NTN.

The control unit 140 performs control related to communications in NTN as described in the embodiments. Further, the control unit 140 controls communications with the terminal 20 based on the radio-parameter-related UE capability report that is received from the UE 20. The functional units related to signal transmission in the control unit 140 may be included in the transmission unit 110, and the functional units related to signal reception in the control unit 140 may be included in the reception unit 120.

### <Terminal 20>

FIG. 20 is a drawing illustrating an example of a functional configuration of a terminal 20 according to an embodiment of the present invention. As shown in FIG. 20, the terminal 20 includes a transmission unit 210, a reception unit 220, a configuration unit 230, and a control unit 240. The functional configuration illustrated in FIG. 20 is merely an example. Functional divisions and names of functional units may be anything as long as operations according to an embodiment of the present invention can be performed.

The transmission unit 210 generates a transmission signal from transmission data and transmits the transmission signal wirelessly. The reception unit 220 receives various signals wirelessly and obtains upper layer signals from the received physical layer signals. Further, the reception unit 220 has a function for receiving NR-PSS, NR-SSS, NR-PBCH, DL/UL/SL control signals, etc., transmitted from the base station 10. Further, for example, with respect to the D2D communications, the transmission unit 210 transmits, to another terminal 20, PSCCH (Physical Sidelink Control Channel), PSSCH (Physical Sidelink Shared Channel), PSDCH (Physical Sidelink Discovery Channel), PSBCH (Physical Sidelink Broadcast Channel), etc., and the reception unit 120 receives, from the another terminal 20, PSCCH, PSSCH, PSDCH, or PSBCH.

The configuration unit 230 stores various configuration information items received by the reception unit 220 from the base station 10. In addition, the configuration unit 230 also stores pre-configured configuration information. Contents are, for example, information related to of the configuration information communications in NTN.

The control unit 240 performs control related to communications in NTN as described in the embodiments. The functional units related to signal transmission in the control unit 240 may be included in the transmission unit 210, and the functional units related to signal reception in the control unit 240 may be included in the reception unit 220.

### (Hardware Structure)

In the above block diagrams used for describing an embodiment of the present invention (FIG. 19 and FIG. 20), functional unit blocks are shown. The functional blocks (function units) are realized by a freely-selected combination of hardware and/or software. Further, realizing means of each functional block is not limited in particular. In other words, each functional block may be realized by a single apparatus in which multiple elements are coupled physically and/or logically, or may be realized by two or more apparatuses that are physically and/or logically separated and are physically and/or logically connected (e.g., wired and/or wireless). The functional blocks may be realized by combining the above-described one or more apparatuses with software.

Functions include, but are not limited to, judging, determining, calculating, processing, deriving, investigating, searching, checking, receiving, transmitting, outputting, accessing, resolving, selecting, establishing, comparing, assuming, expecting, and deeming; broadcasting, notifying, communicating, forwarding, configuring, reconfiguring, allocating, mapping, and assigning, etc. For example, a functional block (component) that functions to transmit is called a transmitting unit or a transmitter. In either case, as described above, the implementation method is not particularly limited.

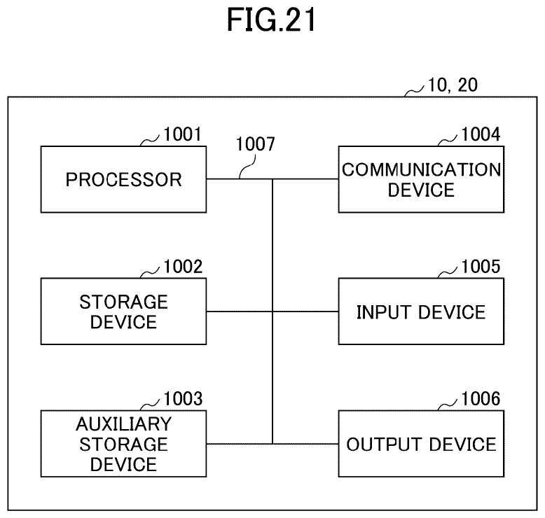

For example, the base station 10, the terminal 20, etc., according to an embodiment of the present disclosure may function as a computer for processing the radio communication method of the present disclosure. FIG. 21 is a drawing illustrating an example of hardware structures of the base station 10 and the terminal 20 according to an embodiment of the present invention. Each of the above-described base station 10 and the terminal 20 may be physically a computer device including a processor 1001, a storage device 1002, an auxiliary storage device 1003, a communication device 1004, an input device 1005, an output device 1006, a bus 1007, etc.

It should be noted that, in the descriptions below, the term “device” can be read as a circuit, a device, a unit, etc. The hardware structures of the base station 10 and the terminal 20 may include one or more of each of the devices illustrated in the figure, or may not include some devices.

Each function in the base station 10 and the terminal 20 is realized by having the processor 1001 perform an operation by reading predetermined software (programs) onto hardware such as the processor 1001 and the storage device 1002, and by controlling communication by the communication device 1004 and controlling at least one of reading and writing of data in the storage device 1002 and the auxiliary storage device 1003.

The processor 1001 controls the entire computer by, for example, controlling the operating system. The processor 1001 may include a central processing unit (CPU) including an interface with a peripheral apparatus, a control apparatus, a calculation apparatus, a register, etc. For example, the above-described control unit 140, control unit 240, and the like, may be implemented by the processor 1001.

Further, the processor 1001 reads out onto the storage device 1002 a program (program code), a software module, or data from the auxiliary storage device 1003 and/or the communication device 1004, and performs various processes according to the program, the software module, or the data. As the program, a program is used that causes the computer to perform at least a part of operations according to an embodiment of the present invention described above. For example, the control unit 140 of the base station 10 illustrated in FIG. 19 may be realized by control programs that are stored in the storage device 1002 and are executed by the processor 1001. Further, for example, the control unit 240 of the terminal 20 illustrated in FIG. 20 may be realized by control programs that are stored in the storage device 1002 and are executed by the processor 1001. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The storage device 1002 is a computer-readable recording medium, and may include at least one of a ROM (Read Only Memory), an EPROM (Erasable Programmable ROM), an EEPROM (Electrically Erasable Programmable ROM), a RAM (Random Access Memory), etc. The storage device 1002 may be referred to as a register, a cache, a main memory, etc. The storage device 1002 is capable of storing programs (program codes), software modules, or the like, that are executable for performing communication processes according to an embodiment of the present invention.

The auxiliary storage device 1003 is a computer-readable recording medium, and may include at least one of, for example, an optical disk such as a CD-ROM (Compact Disc ROM), a hard disk drive, a flexible disk, a magneto optical disk (e.g., compact disc, digital versatile disc, Blu-ray (registered trademark) disk), a smart card, a flash memory (e.g., card, stick, key drive), a floppy (registered trademark) disk, a magnetic strip, etc. The above recording medium may be a database including the storage device 1002 and/or the auxiliary storage device 1003, a server, or any other appropriate medium.

The communication device 1004 is hardware (transmission or reception device) for communicating with computers via at least one of a wired network or a wireless network, and may be referred to as a network device, a network controller, a network card, a communication module, etc. The communication device 1004 may comprise a high frequency switch, duplexer, filter, frequency synthesizer, or the like, for example, to implement at least one of a frequency division duplex (FDD) or a time division duplex (TDD). For example, the transmitting/receiving antenna, the amplifier unit, the transmitting/receiving unit, the transmission line interface, and the like, may be implemented by the communication device 1004. The transmitting/receiving unit may be physically or logically divided into a transmitting unit and a receiving unit.

The input device 1005 is an input device that receives an external input (e.g., keyboard, mouse, microphone, switch, button, sensor). The output device 1006 is an output device that outputs something to the outside (e.g., display, speaker, LED lamp). It should be noted that the input device 1005 and the output device 1006 may be integrated into a single device (e.g., touch panel).

Further, the apparatuses including the processor 1001, the storage device 1002, etc., are connected to each other via the bus 1007 used for communicating information. The bus 1007 may include a single bus, or may include different buses between the apparatuses.

Further, each of the base station 10 and terminal 20 may include hardware such as a microprocessor, a digital signal processor (DSP), an ASIC (Application Specific Integrated Circuit), a PLD (Programmable Logic Device), a FPGA (Field Programmable Gate Array), etc., and a part or all of each functional block may be realized by the hardware. For example, the processor 1001 may be implemented by at least one of the above hardware elements.

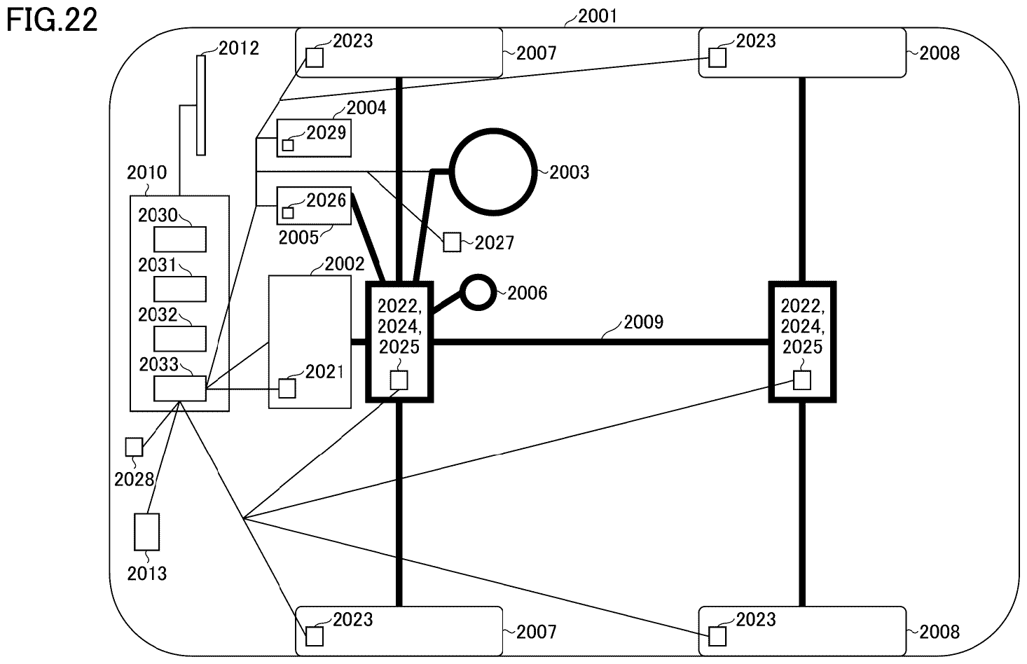

FIG. 22 shows an example of a configuration of a vehicle 2001. As shown in FIG. 22, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021-2029, an information service unit 2012, and a communication module 2013. The aspects/embodiments described in the present disclosure may be applied to a communication device mounted in the vehicle 2001, and may be applied to, for example, the communication module 2013.

The drive unit 2002 may include, for example, an engine, a motor, and a hybrid of an engine and a motor. The steering unit 2003 includes at least a steering wheel and is configured to steer at least one of the front wheel and the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-2029 provided in the vehicle 2001. The electronic control unit 2010 may be referred to as an ECU (Electronic control unit).

The signals from the various sensors 2021 to 2029 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped on accelerator pedal signal acquired by an accelerator pedal sensor 2029, a stepped on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like.

A driving support system unit 2030 includes: various devices for providing functions of preventing accidents and reducing a driver's operating burden such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031 and the memory (ROM, RAM) 2032 in the electronic control unit 2010, and sensors 2021 to 2029 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 transmits a current signal, which is input to the electronic control unit 2010 from the current sensor, to the external devices through radio communication. In addition, the communication module 2013 also transmits, to the external devices through radio communication, the front or rear wheel rotation signal acquired by the revolution sensor 2022, the front or rear wheel pneumatic signal acquired by the pneumatic sensor 2023, the vehicle speed signal acquired by the vehicle speed sensor 2024, the acceleration signal acquired by the acceleration sensor 2025, the stepped-on accelerator pedal signal acquired by the accelerator pedal sensor 2029, the stepped on brake pedal signal acquired by the brake pedal sensor 2026, the operation signal of the shift lever acquired by the shift lever sensor 2027, and the detection signal, acquired by the object detection sensor 2028, for detecting an obstacle, a vehicle, a pedestrian, and the like, that are input to the electronic control unit 2010.

The communication module 2013 receives various types of information (traffic information, signal information, inter-vehicle information, etc.) transmitted from the external devices and displays the received information on the information service unit 2012 provided in the vehicle 2001. In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021-2029, etc., mounted in the vehicle 2001.

### Embodiment Summary

As described above, according to an embodiment of the present invention, a base station is provided. The base station is a base station in a network system, and includes: a transmission unit configured to transmit a first reference signal to a terminal via a first non-terrestrial communication device; and a reception unit configured to receive information related to a reception timing at the terminal from the terminal. The transmission unit transmits information related to a propagation delay of the first reference signal and information related to the reception timing to LMF (Location Management Function), and the information related to the reception timing is a time difference between a reception timing of the first reference signal and a reception timing of a second reference signal that is transmitted from the base station or from a second base station that is different from the base station via a second non-terrestrial communication device.

According to the above-described configuration, in the NTN environment, the gNB and the UE can report the information necessary for positioning of the UE to the LMF, and the LMF can perform positioning of the UE based on the information. In other words, positioning of the terminal can be performed in the network system.

The transmission unit may transmit, to the LMF, a transmission time of the first reference signal and a propagation delay of the first reference signal between the base station and the first non-terrestrial communication device. According to the above-described configuration, in the NTN environment, the gNB and the UE can report the information necessary for positioning of the UE to the LMF, and the LMF can perform positioning of the UE based on the information.

The transmission unit may transmit, to the LMF, a value that is obtained by adding a propagation delay of the first reference signal between the base station and the first non-terrestrial communication device to a transmission time of the first reference signal. According to the above-described configuration, in the NTN environment, the gNB and the UE can report the information necessary for positioning of the UE to the LMF, and the LMF can perform positioning of the UE based on the information.

The transmission unit may transmit, to the LMF: a difference between a transmission time of the first reference signal and a transmission time of the second reference signal; a difference between a propagation delay of the first reference signal between the base station and a first reference point and a propagation delay of the second reference signal between the base station and a second reference point; and a difference between a propagation delay of the first reference signal between the first reference point and the first non-terrestrial communication device and a propagation delay of the second reference signal between the second reference point and the second non-terrestrial communication device. According to the above-described configuration, in the NTN environment, the gNB and the UE can report the information necessary for positioning of the UE to the LMF, and the LMF can perform positioning of the UE based on the information.

The transmission unit may transmit, to the LMF, a value that is obtained by subtracting from a difference between a reception timing of the first reference signal and a reception timing of the second reference signal: a difference between a transmission time of the first reference signal and a transmission time of the second reference signal; a difference between a propagation delay of the first reference signal between the base station and a first reference point and a propagation delay of the second reference signal between the base station and a second reference point; and a difference between a propagation delay of the first reference signal between the first reference point and the first non-terrestrial communication device and a propagation delay of the second reference signal between the second reference point and the second non-terrestrial communication device. According to the above-described configuration, in the NTN environment, the gNB and the UE can report the information necessary for positioning of the UE to the LMF, and the LMF can perform positioning of the UE based on the information.

In addition, according to an embodiment of the present invention, a communication method performed by a base station in a network system is provided. The communication method includes: transmitting a first reference signal to a terminal via a first non-terrestrial communication device; receiving information related to a reception timing at the terminal from the terminal; transmitting information related to a propagation delay of the first reference signal and information related to the reception timing to LMF (Location Management Function), and the information related to the reception timing is a time difference between a reception timing of the first reference signal and a reception timing of a second reference signal that is transmitted from the base station or from a second base station that is different from the base station via a second non-terrestrial communication device.

According to the above-described configuration, in the NTN environment, the gNB and the UE can report the information necessary for positioning of the UE to the LMF, and the LMF can perform positioning of the UE based on the information. In other words, positioning of the terminal can be performed in the network system.

### Supplement of Embodiment

As described above, one or more embodiments have been described. The present invention is not limited to the above embodiments. A person skilled in the art should understand that there are various modifications, variations, alternatives, replacements, etc., of the embodiments. In order to facilitate understanding of the present invention, specific values have been used in the description. However, unless otherwise specified, those values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and flowcharts described in an embodiment of the present invention may be changed as long as there is no contradiction. For the sake of description convenience, the base station 10 and the terminal 20 have been described by using functional block diagrams. However, the apparatuses may be realized by hardware, software, or a combination of hardware and software. The software executed by a processor included in the base station 10 according to an embodiment of the present invention and the software executed by a processor included in the terminal 20 according to an embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate recording medium.

Further, information indication may be performed not only by methods described in an aspect/embodiment of the present specification but also a method other than those described in an aspect/embodiment of the present specification. For example, the information indication may be performed by physical layer signaling (e.g., DCI (Downlink Control Information), UCI (Uplink Control Information)), upper layer signaling (e.g., RRC (Radio Resource Control) signaling, MAC (Medium Access Control) signaling, broadcast information (MIB (Master Information Block), SIB (System Information Block))), other signals, or combinations thereof. Further, RRC signaling may be referred to as an RRC message. The RRC signaling may be, for example, an RRC connection setup message, an RRC connection reconfiguration message, or the like.

Each aspect/embodiment described in the present disclosure may be applied to at least one of a system using LTE (Long Term Evolution), LTE-A (LTE-Advanced), SUPER 3G, IMT-Advanced, 4G (4th generation mobile communication system), 5G (5th generation mobile communication system), 6th generation mobile communication system (6G), xth generation mobile communication system (xG) (xG (x is, for example, an integer or a decimal)), FRA (Future Radio Access), NR (new Radio), New radio access (NX), Future generation radio access (FX), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and a next generation system enhanced, modified, developed, or defined therefrom. Further, multiple systems may also be applied in combination (e.g., at least one of LTE or LTE-A combined with 5G, etc.).

The order of processing steps, sequences, flowcharts or the like of an aspect/embodiment described in the present specification may be changed as long as there is no contradiction. For example, in a method described in the present specification, elements of various steps are presented in an exemplary order. The order is not limited to the presented specific order.

The particular operations, that are supposed to be performed by the base station 10 in the present specification, may be performed by an upper node in some cases. In a network including one or more network nodes including the base station 10, it is apparent that various operations performed for communicating with the terminal 20 may be performed by the base station 10 and/or another network node other than the base station 10 (for example, but not limited to, MME or S-GW). According to the above, a case is described in which there is a single network node other than the base station 10. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Software should be broadly interpreted to mean, whether referred to as software, firmware, middle ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms “Base Station (BS)”, “Radio Base Station”, “Base Station Apparatus”, “Fixed Station”, “NodeB”, “eNodeB (eNB)”, “gNodeB (gNB)”, “Access Point”, “Transmission Point”, “Reception Point”, “Transmission/Reception Point”, “Cell”, “Sector”, “Cell Group”, “Carrier”, “Component Carrier”, and the like, may be used interchangeably. The base station may be referred to as a macro-cell, a small cell, a femtocell, a picocell and the like.

The base station may accommodate (provide) one or more (e.g., three) cells. In the case where the base station accommodates a plurality of cells, the entire coverage area of the base station may be divided into a plurality of smaller areas, and each smaller area may provide communication services by means of a base station subsystem (e.g., an indoor small base station or a remote Radio Head (RRH)). The term “cell” or “sector” refers to a part or all of the coverage area of at least one of the base station and base station subsystem that provides communication services at the coverage.

In the present disclosure, terms such as “mobile station (MS)”, “user terminal”, “user equipment (UE)”, “terminal”, and the like, may be used interchangeably.

There is a case in which the mobile station may be referred to, by a person skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

At least one of the base station or the mobile station may be referred to as a transmission apparatus, reception apparatus, communication apparatus, or the like. The at least one of the base station or the mobile station may be a device mounted on the mobile station, the mobile station itself, or the like. The mobile station may be a vehicle (e.g., a car, an airplane, etc.), an unmanned mobile body (e.g., a drone, an automated vehicle, etc.), or a robot (manned or unmanned). At least one of the base station or the mobile station may include an apparatus that does not necessarily move during communication operations. For example, at least one of the base station or the mobile station may be an IoT (Internet of Things) device such as a sensor.

Further, the base station in the present disclosure may be read as the user terminal. For example, each aspect/embodiment of the present disclosure may be applied to a configuration in which communications between the base station and the user terminal are replaced by communications between multiple terminals 20 (e.g., may be referred to as D2D (Device-to-Device), V2X (Vehicle-to-Everything), etc.). In this case, the function of the base station 10 described above may be provided by the terminal 20. Further, the phrases “up” and “down” may also be replaced by the phrases corresponding to terminal-to-terminal communication (e.g., “side”). For example, an uplink channel, a downlink channel, or the like, may be read as a sidelink channel.

Further, the user terminal in the present disclosure may be read as the base station. In this case, the function of the user terminal described above may be provided by the base station.

The term “determining” used in the present specification may include various actions or operations. The terms “determination” and “decision” may include “determination” and “decision” made with judging, calculating, computing, processing, deriving, investigating, searching (looking up, search, inquiry) (e.g., search in a table, a database, or another data structure), or ascertaining. Further, the “determining” may include “determining” made with receiving (e.g., receiving information), transmitting (e.g., transmitting information), inputting, outputting, or accessing (e.g., accessing data in a memory). Further, the “determining” may include a case in which “resolving”, “selecting”, “choosing”, “establishing”, “comparing”, or the like is deemed as “determining”. In other words, the “determining” may include a case in which a certain action or operation is deemed as “determining”. Further, “decision” may be read as “assuming”, “expecting”, or “considering”, etc.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

The reference signal may be abbreviated as RS or may be referred to as a pilot, depending on the applied standards.

The description “based on” used in the present specification does not mean “based on only” unless otherwise specifically noted. In other words, the phrase “based on” means both “based on only” and “based on at least”.

Any reference to an element using terms such as “first” or “second” as used in the present disclosure does not generally limit the amount or the order of those elements. These terms may be used in the present disclosure as a convenient way to distinguish between two or more elements. Therefore, references to the first and second elements do not imply that only two elements may be employed or that the first element must in some way precede the second element.

“Means” included in the configuration of each of the above apparatuses may be replaced by “parts”, “circuits”, “devices”, etc.

In the case where the terms “include”, “including” and variations thereof are used in the present disclosure, these terms are intended to be comprehensive in the same way as the term “comprising”. Further, the term “or” used in the present specification is not intended to be an “exclusive or”.

A radio frame may include one or more frames in the time domain. Each of the one or more frames in the time domain may be referred to as a subframe. The subframe may further include one or more slots in the time domain. The subframe may be a fixed length of time (e.g., 1 ms) independent from the numerology.

The numerology may be a communication parameter that is applied to at least one of the transmission or reception of a signal or channel. The numerology may indicate at least one of, for example, SubCarrier Spacing (SCS), bandwidth, symbol length, cyclic prefix length, transmission time interval (TTI), number of symbols per TTI, radio frame configuration, specific filtering processing performed by the transceiver in the frequency domain, or specific windowing processing performed by the transceiver in the time domain.

The slot may include one or more symbols in the time domain, such as OFDM (Orthogonal Frequency Division Multiplexing) symbols, SC-FDMA (Single Carrier Frequency Division Multiple Access) symbols, and the like. The slot may be a time unit based on the numerology.

The slot may include a plurality of mini slots. Each mini slot may include one or more symbols in the time domain. Further, the mini slot may be referred to as a sub-slot. The mini slot may include fewer symbols than the slot. PDSCH (or PUSCH) transmitted in time units greater than a mini slot may be referred to as PDSCH (or PUSCH) mapping type A. PDSCH (or PUSCH) transmitted using a mini slot may be referred to as PDSCH (or PUSCH) mapping type B.

A radio frame, a subframe, a slot, a mini slot and a symbol all represent time units for transmitting signals. Different terms may be used for referring to a radio frame, a subframe, a slot, a mini slot and a symbol, respectively.

For example, one subframe may be referred to as a transmission time interval (TTI), multiple consecutive subframes may be referred to as a TTI, and one slot or one mini slot may be referred to as a TTI. In other words, at least one of the subframe and the TTI may be a subframe (1 ms) in an existing LTE, a period shorter than 1 ms (e.g., 1-13 symbols), or a period longer than 1 ms. It should be noted that the unit representing the TTI may be referred to as a slot, a mini slot, or the like, rather than a subframe.

The TTI refers to, for example, the minimum time unit for scheduling in wireless communications. For example, in an LTE system, a base station schedules each terminal 20 to allocate radio resources (such as frequency bandwidth, transmission power, etc. that can be used in each terminal 20) in TTI units. The definition of TTI is not limited to the above.

The TTI may be a transmission time unit, such as a channel-encoded data packet (transport block), code block, codeword, or the like, or may be a processing unit, such as scheduling or link adaptation. It should be noted that, when a TTI is provided, the time interval (e.g., the number of symbols) during which the transport block, code block, codeword, or the like, is actually mapped may be shorter than the TTI.

It should be noted that, when one slot or one mini slot is referred to as a TTI, one or more TTIs (i.e., one or more slots or one or more mini slots) may be the minimum time unit for scheduling. Further, the number of slots (the number of mini slots) constituting the minimum time unit of the scheduling may be controlled.

A TTI having a time length of 1 ms may be referred to as a normal TTI (a TTI in LTE Rel. 8-12), a long TTI, a normal subframe, a long subframe, a slot, and the like. A TTI that is shorter than the normal TTI may be referred to as a shortened TTI, a short TTI, a partial TTI (or fractional TTI), a shortened subframe, a short subframe, a mini slot, a subslot, a slot, or the like.

It should be noted that the long TTI (e.g., normal TTI, subframe, etc.,) may be replaced with a TTI having a time length exceeding 1 ms, and the short TTI (e.g., shortened TTI, etc.,) may be replaced with a TTI having a TTI length less than the TTI length of the long TTI and a TTI length greater than 1 ms.

A resource block (RB) is a time domain and frequency domain resource allocation unit and may include one or more consecutive subcarriers in the frequency domain. The number of subcarriers included in an RB may be the same, regardless of the numerology, and may be 12, for example. The number of subcarriers included in an RB may be determined on the basis of numerology.

Further, the time domain of an RB may include one or more symbols, which may be 1 slot, 1 mini slot, 1 subframe, or 1 TTI in length. One TTI, one subframe, etc., may each include one or more resource blocks.

It should be noted that one or more RBs may be referred to as physical resource blocks (PRBs, Physical RBs), sub-carrier groups (SCGs), resource element groups (REGs), PRB pairs, RB pairs, and the like.

Further, a resource block may include one or more resource elements (RE). For example, 1 RE may be a radio resource area of one sub carrier and one symbol.

The bandwidth part (BWP) (which may also be referred to as a partial bandwidth, etc.) may represent a subset of consecutive common RBs (common resource blocks) for a given numerology in a carrier. Here, a common RB may be identified by an index of RB relative to the common reference point of the carrier. A PRB may be defined in a BWP and may be numbered within the BWP.

BWP may include BWP for UL (UL BWP) and BWP for DL (DL BWP). For a UE, one or more BWPs may be configured in one carrier.

At least one of the configured BWPs may be activated, and the UE may assume that the UE will not transmit and receive signals/channels outside the activated BWP. It should be noted that the terms “cell” and “carrier” in this disclosure may be replaced by “BWP.”

Structures of a radio frame, a subframe, a slot, a mini slot, and a symbol described above are exemplary only. For example, the number of subframes included in a radio frame, the number of slots per subframe or radio frame, the number of mini slots included in a slot, the number of symbols and RBs included in a slot or mini slot, the number of subcarriers included in an RB, the number of symbols in a TTI, the symbol length, the cyclic prefix (CP) length, and the like, may be changed in various ways.

In the present disclosure, where an article is added by translation, for example “a”, “an”, and “the”, the disclosure may include that the noun following these articles is plural.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

An aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### DESCRIPTION OF THE REFERENCE NUMERALS

10 Base station
110 Transmission unit
120 Reception unit
130 Configuration unit
140 Control unit
20 Terminal
210 Transmission unit
220 Reception unit
230 Configuration unit
240 Control unit
1001 Processor
1002 Storage device
1003 Auxiliary storage device
1004 Communication device
1005 Input device
1006 Output device

1. A base station in a network system, the base station comprising:
a transmission unit configured to transmit a first reference signal to a terminal via a first non-terrestrial communication device; and
a reception unit configured to receive information related to a reception timing at the terminal from the terminal, wherein
the transmission unit transmits information related to a propagation delay of the first reference signal and information related to the reception timing to LMF (Location Management Function), and
the information related to the reception timing is a time difference between a reception timing of the first reference signal and a reception timing of a second reference signal that is transmitted from the base station or from a second base station that is different from the base station via a second non-terrestrial communication device.

2. The base station as claimed in claim 1, wherein
the transmission unit transmits, to the LMF, a transmission time of the first reference signal and a propagation delay of the first reference signal between the base station and the first non-terrestrial communication device.

3. The base station as claimed in claim 1, wherein
the transmission unit transmits, to the LMF, a value that is obtained by adding a propagation delay of the first reference signal between the base station and the first non-terrestrial communication device to a transmission time of the first reference signal.

4. The base station as claimed in claim 1, wherein
the transmission unit transmits, to the LMF: a difference between a transmission time of the first reference signal and a transmission time of the second reference signal; a difference between a propagation delay of the first reference signal between the base station and a first reference point and a propagation delay of the second reference signal between the base station and a second reference point; and a difference between a propagation delay of the first reference signal between the first reference point and the first non-terrestrial communication device and a propagation delay of the second reference signal between the second reference point and the second non-terrestrial communication device.

5. The base station as claimed in claim 1, wherein
the transmission unit transmits, to the LMF, a value that is obtained by subtracting from a difference between a reception timing of the first reference signal and a reception timing of the second reference signal: a difference between a transmission time of the first reference signal and a transmission time of the second reference signal; a difference between a propagation delay of the first reference signal between the base station and a first reference point and a propagation delay of the second reference signal between the base station and a second reference point; and a difference between a propagation delay of the first reference signal between the first reference point and the first non-terrestrial communication device and a propagation delay of the second reference signal between the second reference point and the second non-terrestrial communication device.

6. A communication method performed by a base station in a network system, the communication method comprising:
transmitting a first reference signal to a terminal via a first non-terrestrial communication device;
receiving information related to a reception timing at the terminal from the terminal; and
transmitting information related to a propagation delay of the first reference signal and information related to the reception timing to LMF (Location Management Function), wherein
the information related to the reception timing is a time difference between a reception timing of the first reference signal and a reception timing of a second reference signal that is transmitted from the base station or from a second base station that is different from the base station via a second non-terrestrial communication device.
